(19) United States
(12) Patent Application Publication
(10) Pub. No.: US 2025/0266470 A1
(43) Pub. Date: Aug. 21, 2025

(54) STACKABLE ELECTRO-SYNTHETIC OR ELECTRO-ENERGY CELLS

(71) Applicant: Hysata Pty Ltd, Port Kembla, New South Wales (AU)

(72) Inventors: David John COX, Northbridge, New South Wales (AU); Gerhard Frederick SWIEGERS, North Wollongong, New South Wales (AU); Scott ABRAHAMSON, Niwot, CO (US); Mark Simbajon ROMANO, Kembla Grange, New South Wales (AU); Robert MCCONVILLE, Belmore, Victoria (AU); Adam WARBURTON, Drummoyne, New South Wales (AU)

(21) Appl. No.: 18/854,885

(22) PCT Filed: Apr. 6, 2023
(86) PCT No.: PCT/AU2023/050278

§ 371 Date: Oct. 7, 2024

(30) Foreign Application Priority Data
Apr. 7, 2022 (AU) 2022900916
Apr. 19, 2022 (AU) 2022901037
Dec. 9, 2022 (AU) 2022903770

(51) Int. Cl. H01M 8/0273; C25B 9/05; C25B 9/73; C25B 13/02; C25B 13/08; C25B 15/08; H01M 8/0284; H01M 8/083; H01M 8/086; H01M 8/10; H01M 8/242; H01M 8/248; H01M 8/2483

(52) U.S. Cl. CPC H01M 8/0273; C25B 9/05; C25B 9/73; C25B 13/02; C25B 13/08; C25B 15/08; H01M 8/0284; H01M 8/242; H01M 8/248; H01M 8/2483; H01M 8/083; H01M 8/086; H01M 2008/1095

(57) ABSTRACT

Electro-energy or electro-synthetic cells whose architectures allow them to be readily stacked into a cell stack. The cells include polymeric cell frames that incorporate within them, functional materials, such as an inter-electrode separator, electrodes, metallic bipolar plates, and the like. For example, an electro-energy or electro-synthetic cell includes a polymeric cell frame, a first electrode and a second electrode, and an inter-electrode separator positioned between the first electrode and the second electrode. A compressive component is positioned adjacent to the first electrode. The compressive component may be a metallic bipolar plate compressive component and/or a metallic porous transport layer compressive component. In one example the polymeric cell frame is sealed to the metallic bipolar plate by a polymer-to-metal join. In another example at least one polymeric structural locating component locates the metallic bipolar plate against the polymeric cell frame. A cell stack includes a plurality of the cells.

### TECHNICAL FIELD

The invention broadly relates to electrochemical cells, for example used as electro-synthetic cells or electro-energy cells. Example embodiments relate to cells whose architectures allow the cells to be readily stacked into industrial cell stacks that, effectively, constitute a single electro-synthetic or electro-energy device or apparatus.

### BACKGROUND

An electro-energy cell is an electrochemical cell that generates electrical power over sustained periods of time, for use outside of the cell. Electro-energy cells are distinguished from other galvanic cells in that they require a constant external supply of reactants. The products of the electrochemical reaction must also be constantly removed from such cells. Unlike a battery, an electro-energy cell does not store chemical or electrical energy within the electro-energy cell.

Examples of electro-energy cells include but are not limited to Polymer Electrolyte Membrane (PEM) hydrogen-oxygen fuel cells, hydrogen-oxygen alkaline fuel cells, ammonia fuel cells, and the like.

An electro-synthetic cell may be similarly considered to be an electrochemical cell that manufactures one or more chemical materials over sustained periods of time, for use outside of the cell. The chemical materials may be in the form of a gas, liquid, or solid. Like an electro-energy cell, an electro-synthetic cell also requires a constant supply of reactants and a constant removal of products. Electro-synthetic cells may generally further require a constant input of electrical energy.

Examples of electro-synthetic cells include but are not limited to: water electrolysis cells, chlor-alkali cells, and cells for manufacturing hydrogen peroxide, ammonia and the like.

Another feature of electro-synthetic or electro-energy cells is the large quantities of reactants and products that are typically involved in their operation. Such cells need to be constantly fed with substantial amounts of reactants, whilst significant volumes of products must be, simultaneously, constantly removed.

Because of the large quantities of electrical energy involved in operating electro-energy and electro-synthetic cells, a key challenge in their development is to make them as energy efficient as possible during operation. This may be achieved, in part, by minimizing their electrical impedance. Impedance is the opposition that a cell circuit presents to an electrical current when a voltage is applied. One well-known method of minimizing impedance is to employ a cell architecture in which the anode and cathode electrodes of the cell are placed facing each other, as close as possible to each other, without touching (which would create a short circuit). The gap between the two electrodes should then, ideally, also be occupied by an electrolyte having the highest possible conductivity. In general, liquid electrolytes, as a class, have the highest conductivities. The liquid electrolyte may be incorporated within a porous inter-electrode spacer which stops the electrodes from touching one another. Accordingly, many electro-energy or electro-synthetic cells employ liquid electrolyte, which may be highly conductive, within the cell, or a component half-cell, itself.

Another issue with electro-energy or electro-synthetic cells of this type is that, in industrial applications, they are often ideally ‘stacked’ in electrical series with multiple other cells to thereby create a ‘cell stack’. This is most commonly achieved within a so-called ‘filter-press’ arrangement. In such an arrangement, individual cells having a substantially flat profile are stacked between two endplates.

The challenges with fabricating and maintaining filter-press-type cell stacks are well known. It is, firstly, essential that the design and architecture of the cells must allow them to be easily and reliably combined into filter-press-type cells stack. This means that when the cells are compressed together, between the endplates, to form the filter-press-type cell stack, they should seal each other to thereby ensure that there are no leaks of liquid and/or gases from the cell stack, or unwanted mixing of liquids and/or gases within the stack. This often requires a very particular and/or high, overall level of compression as well as a very even distribution of the compression across the lateral length of the cells in the stack. Moreover, the compression may need to be very evenly spread over each face of each individual cell, so that there are no locations of excessive or insufficient compression on the front or back face of any of the cells in the stack. Each cell may further need to be very precisely positioned relative to the other cells prior to and during the application of the compression. Achieving these requirements is often difficult, especially in mass production environments where such precision must be realised in the minimum of time.

Additionally, after formation of the cell stack, the often very high and/or very particular compression may typically have to be precisely maintained to ensure that no leaks of liquid and/or gases, or unwanted mixing of liquids and/or gases, occur during electrochemical operation. However, cell stacks may be cycled between low and high temperatures and low and high pressures during operation, causing thermal and/or pressure-induced expansion and contraction of the cells in the stack. The resulting dimensional changes may alter the lateral and facial compression experienced by individual cells, inducing leaks of liquid and/or gases from the cell stack, or unwanted mixing of liquids and/or gases within the stack. For this reason, the rate of thermal or pressure-induced expansion of each of the cell components need to be carefully considered and matched wherever possible. Where this is not possible or viable, suitable gaskets must be applied between adjacent components to avoid leaks of liquid and/or gases from the cell stack, or unwanted mixing of liquids and/or gases within the stack. However, gaskets may move or degrade during successive thermal and/or pressure cycles, causing them to fail. Finding ways to minimise or, at least, reduce the number of gaskets needed and the operating stresses applied to them within a stack forms an important field of innovation.

By way of example, known electrochemical stacks employ metallic plates, known as bipolar plates, that lie between the cells in a stack and are held in position only by the compression applied to the stack as a whole. A bipolar plate is a conductive plate in an electro-energy or electro-synthetic cell stack that connects an anode for one cell and a cathode in the adjacent cell. Its primary function is to accumulate and uniformly distribute an electrical current from one cell to the next. Bipolar plates may have complex patterns for fluid flow etched, machined, stamped, sunk, or otherwise formed on their faces. These patterns, often known as flow fields, may comprise of pits (namely, low points on the metallic structure) and lands (namely, high points on the metallic structure), or ribs and spaces, or steps and voids. For example, metallic bipolar plates with serpentine flow fields have one or more channels in a serpentine arrangement sunk into their face. Metallic flow fields of this type may often be most conveniently produced by high-speed, high-volume imprinting of the flow field into the metal plate using an industrial precision stamping or forming process. However, the physical dimensions of the structure thus created in the metal plate, may change a little due to ‘springback’ of the metal in the plate. The resulting dimensional changes may cause serious problems in a stack containing such bipolar plates, due to leaking, incorrect flow dynamics, or the like, arising from the dimensional changes. A major challenge to industrialising cell stack production is therefore to produce components in high-speed, high-volume processes that yield structures with minimal variations in their physical dimensions (i.e. that display high ‘tolerances’). Alternatively, new approaches are needed to successfully and reliably form cell stacks using components with structures that display notable variations in their physical dimensions (i.e. that display low ‘tolerances’).

Another metallic component often used in electro-synthetic or electro-energy cells is known as a porous transport layer. A porous transport layer is a conductive, metallic structure that is porous to liquid and/or gaseous fluids, and that typically lies between an electrode and its bipolar plate. The porous transport layer provides an electrical connection between the electrode and the bipolar plate, whilst simultaneously allowing for movement of liquid or gas to or from the electrode.

Accordingly, a need exists to address or ameliorate one or more of these problems. For example, a need exists to develop cells or components that can be simply and reliably formed into cell stacks that do not leak or mix the liquid or gas reactants and products, both during the stack assembly process itself and thereafter, during subsequent operation. In another example, a need exists to develop approaches to the assembly of cell components with low tolerances that result in reliable and successful cell stacks that do not leak or mix the liquid or gas reactants and products, both during cell stack formation and thereafter, during subsequent operation. This needs to be achieved whilst simultaneously providing for high energy efficiency in the operation of the cells and cell stacks.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify all of the key features or essential features of the claimed subject matter, nor is it intended to be used to limit the scope of the claimed subject matter.

In various example aspects, embodiments relate to electro-energy or electro-synthetic cell architectures that provide for simplified and reliable assembly into or within cell stacks that do not leak or mix the liquid or gas reactants and products, both after assembly and during subsequent operation, and that provide for high energy efficiency.

Example embodiments relate to electro-energy or electro-synthetic cell architectures comprising of polymeric cell frames that incorporate within them or about them, functional materials, such as an inter-electrode separator, electrodes, porous transport layers, bipolar plates, and the like. Preferably, some or all of the individual functional materials may be attached to the cell frame. For example, a polymeric inter-electrode separator may be attached to the polymeric cell frame via one or more polymer-to-polymer joins. The polymer-to-polymer joins may seal the junction between the polymeric inter-electrode separator and the polymeric cell frame to, for example, leaks of gas from one side of the inter-electrode separator to the other, across the thickness of the inter-electrode separator.

Preferably, the polymeric inter-electrode separator is thin, to thereby maximise the energy efficiency of the cell. Preferably, the polymeric inter-electrode separator is less than 0.35 mm thick, less than 0.2 mm thick, less than 0.1 mm thick, less than 0.05 mm thick, or less than 0.025 mm thick.

In another example, one or more of the metallic functional materials may be attached to the polymer frame via one or more polymer-to-metal joins. For example, a metallic bipolar plate may be attached to the cell frame via one or more polymer-to-metal joins. The polymer-to-metal joins may seal the junction between the metallic bipolar plate and the polymeric cell frame to, for example, leaks of liquid or gas to or from the outside of the cell.

In various aspects there are provided assembled, ‘internally compressed’ electro-energy or electro-synthetic cells whose architectures allow them to be readily stacked into a cell stack. The cells comprise polymeric cell frames that incorporate within them, functional materials, such as an inter-electrode separator, electrodes, metallic bipolar plates, and the like. For example, an electro-energy or electro-synthetic cell comprises a polymeric cell frame, a first electrode and a second electrode, and an inter-electrode separator positioned between the first electrode and the second electrode. A compressive component is positioned adjacent to the first electrode, upon which the compressive component exerts a clamping force, compressing the first electrode against the inter-electrode separator. The compressive component may be a metallic bipolar plate compressive component and/or a metallic porous transport layer compressive component.

In one example the polymeric cell frame is sealed to the metallic bipolar plate by a polymer-to-metal join that, fully or partially, imparts the rigidity needed in the assembled cell to create the abovementioned clamping force. In another example at least one polymeric ‘structural locating component’, bound to the polymeric cell frame by a polymer-to-polymer join, locates the metallic bipolar plate against the polymeric cell frame and, fully or partially, imparts the rigidity needed in the assembled cell to create the abovementioned clamping force.

A polymeric ‘structural locating component’ is a polymeric structure in an electro-synthetic or electro-energy cell that, when attached to the polymeric cell frame by one or more polymer-to-polymer joins, mechanically holds a physically disconnected metallic structure in a suitable position within or about the cell and/or cell frame.

A ‘compressive component’ is a springed or sprung structure that, when suitably positioned in an assembled cell, exerts a clamping force on at least one of the electrodes, compressing at least one of the electrodes against the inter-electrode separator. In so doing, the cell, after assembly, is ‘internally compressed’. Such ‘internal compression’ diminishes or avoids the need to create the necessary clamping force during formation of the cell stack. In conventional electro-energy or electro-synthetic filter-press cell stacks, the necessary clamping force in each cell is created during compression and assembly of the cell stack, which involves the simultaneous assembly and compression of a multiplicity of cells. However, when cells that have been pre-assembled to be ‘internally compressed’ are combined into a cell stack, they may not need to be as accurately positioned and precisely compressed as would normally be required. That is, pre-assembling the individual cells in an ‘internally compressed’ form, may simplify and speed up the process of cell stack formation, which may be useful in high volume, automated manufacturing of cell stacks. Such pre-assembled and ‘internally compressed’ cells may also be individually tested and subjected to quality control and verification procedures before they are combined into a cell stack, to thereby ensure they will function correctly in the stack. This option is not available in conventional filter-press cell stacks, where the individual cells are only assembled into functional units during formation of the cell stack. If one cell so assembled, proves to function incorrectly, the entire stack must be disassembled to remove it. Preferably, the abovementioned springed or sprung action is created within at least one of a metallic bipolar plate or a metallic porous transport layer.

A ‘bipolar plate compressive component’ is a bipolar plate that also has a compressive function. That is, the bipolar plate compressive component is a springed or sprung structure that, when positioned in the assembled cell, exerts a clamping force on its associated electrode, compressing the associated electrode against the inter-electrode separator. It is to be understood that such a springed action is, preferably, designed into the bipolar plate compressive component so that the bipolar plate compressive component imparts a specific, pre-determined clamping force, within a relatively narrow range of clamping forces, to the electrode. The bipolar plate compressive component does not impart a clamping force merely adventitiously or in an uncontrolled or non-repeatable manner. Preferably, the clamping force within the assembled cell is created, fully or partially, by the rigidity of: (1) a polymer-to-metal join between the bipolar plate compressive component and the polymeric cell frame, or (2) a polymer-to-polymer join between a ‘polymeric structural locating’ element and the polymeric cell frame.

A ‘porous transport layer compressive component’ is a porous transport layer that also has a compressive function. That is, the porous transport layer compressive component is a springed or sprung structure that, when suitably positioned in the assembled cell, exerts a clamping force on its associated electrode, compressing the associated electrode against the inter-electrode separator. It is to be understood that such a springed action is, preferably, designed into the porous transport layer compressive component so that it imparts a specific, pre-determined clamping force, within a relatively narrow range of clamping forces, to the electrode. The porous transport layer compressive component does not impart a clamping force merely adventitiously or in an uncontrolled or non-repeatable manner. Preferably, the clamping force within the cell is created, fully or partially, by the rigidity of: (1) a polymer-to-metal join between the bipolar plate compressive component and the polymeric cell frame, or (2) a polymer-to-polymer join between a ‘polymeric structural locating’ element and the polymeric cell frame.

There is, further, provided different compressive components, for example, a ‘metallic bipolar plate compressive component’, a ‘metallic porous transport layer compressive component’, and/or a ‘metallic electrode compressive component’. Such structures are metallic structures that are springed or sprung structures that, when suitably positioned in the assembled cell, exert a clamping force on the associated electrode, compressing it against the inter-electrode separator.

Preferably, the clamping force applied internally within an assembled cell, by a compressive component upon an electrode, compressing the electrode against the inter-electrode separator, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.

Preferably, the clamping force applied internally within the cell when assembled, by a metallic bipolar plate compressive component upon the first electrode or the second electrode, compressing the first electrode or the second electrode against the inter-electrode separator, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.

Preferably, the compression applied internally within an assembled cell is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.

Preferably but not exclusively, the cell architecture also incorporates at least one ‘compliant’ component that displaces to uniformly accommodate and distribute the compressive force exerted by the at least one springed or sprung component. Optionally, the compliant component comprises at least one of, a metallic bipolar plate, a metallic porous transport layer, or a metallic electrode. That is, there can be provided different compliant components, for example, a ‘metallic bipolar plate compliant component’, a ‘metallic porous transport layer compliant component’, and/or a ‘metallic electrode compliant component’.

In one aspect there is provided an electro-energy or electro-synthetic cell comprising a polymeric cell frame, a first electrode and a second electrode. An inter-electrode separator is positioned between the first electrode and the second electrode. A metallic bipolar plate compressive component is positioned adjacent to the first electrode upon which the bipolar plate compressive component exerts a clamping force, compressing the first electrode against the inter-electrode separator. Preferably, the polymeric cell frame is sealed to the metallic bipolar plate compressive component.

In one example, a seal between the polymeric cell frame and the metallic bipolar plate compressive component is created by a polymer-to-metal join. In another example, at least one polymeric structural locating component joined to the cell frame by one or more polymer-to-polymer joins locates the metallic bipolar plate compressive component against the polymeric cell frame. In this example, a seal between the polymeric cell frame and the metallic bipolar plate compressive component can be created by one or more polymer-to-polymer joins between the at least one polymeric structural locating component and the polymeric cell frame and the at least one polymeric structural locating component mechanically holding the metallic bipolar plate compressive component against the polymeric cell frame.

In another aspect there is provided an electro-energy or electro-synthetic cell comprising a polymeric cell frame, a first electrode and a second electrode. An inter-electrode separator is positioned between the first electrode and the second electrode. A metallic porous transport layer compressive component is positioned adjacent to the first electrode on the opposite side to the inter-electrode separator. A metallic bipolar plate is positioned adjacent to the metallic porous transport layer compressive component on the opposite side to the first electrode. Preferably, the metallic bipolar plate is affixed to the polymeric cell frame by one or more polymer-to-metal joins, or at least one polymeric structural locating component joined to the cell frame by one or more polymer-to-polymer joins, locates the metallic bipolar plate against the polymeric cell frame.

Preferably but not exclusively, some or all of the metallic functional materials for each half-cell within the overall cell may, further, be attached to each other via one or more metal-to-metal joins, for example, by one or more metal-to-metal welds. For example, a metallic electrode and a metallic bipolar plate, comprising metallic components of a single half-cell, may be attached to each other via one or more metal-to-metal joins, for example, by one or more metal-to-metal welds. In an alternative example, a metallic electrode, a metallic porous transport layer, and a metallic bipolar plate, comprising metallic components of a single half-cell, may be attached to each other via one or more metal-to-metal joins, for example, by one or more metal-to-metal welds. The term ‘metal-to-metal weld’ as used herein refers to any form of metallurgical metal-to-metal join that may be considered to involve a weld, including but not limited to fusion welding and pressure welding.

Metal-to-metal joins such as, for example, metal-to-metal welds, may provide for reduced or unchanging electrical resistance between metallic functional materials, thereby providing for improved energy efficiency by the cell during operation. Preferred embodiments may employ such metal-to-metal joined structures because the compression involved in cell assembly may be too low to damage or destroy the metal-to-metal joins, for example metal-to-metal welds. Moreover, when the assembled cells are then combined into cell stacks, low compression may, again, be required. By contrast, as noted in the Background section, in conventional cell stack formation, very much higher compression is typically required; such high compression may readily damage or destroy any metal-to-metal joins present, for example, metal-to-metal welds. C

Preferably but not exclusively, one or more of the metallic functional materials thus attached to each other, may be further attached to the polymeric cell frame via one or more metal-to-polymer joins. For example, the bipolar plate in a metal-to-metal joined assembly of the aforementioned type may be attached to the polymeric cell frame by one or more metal-to-polymer joins. The metal-to-polymer joins may seal the junction between the metallic bipolar plate and the polymeric cell frame to, for example, leaks of liquid or gas to or from the outside of the cell.

In another example aspect, polymeric ‘structural locating components’ are provided. When attached to the polymeric frame via one or more polymer-to-polymer joins, such polymeric ‘structural locating components’ may mechanically hold one or more of the metallic functional materials in suitable positions within or about the cell frame after assembly of the cell. In so doing, the metallic functional materials may be suitably positioned within or about the cell frame without being physically joined to the cell frame. For example, a ‘structural locating component’ may be attached to the polymeric cell frame via one or more polymer-to-polymer joins to thereby mechanically hold the aforementioned metal-to-metal joined assembly of a metallic electrode and a metallic bipolar plate, with, optionally a metallic porous transport layer, in a suitable position within or about the cell frame after assembly of the cell. In so doing, the assembly of metallic functional materials may not be physically joined to the polymeric cell frame after assembly of the cell. The metallic bipolar plate of the assembly of metallic functional materials may, nevertheless, be positioned tight up against or very close to the polymeric cell frame. They may be positioned so tightly that the junction is sealed to, for example, leaks of liquid or gas to or from the outside of the cell. Alternatively, a suitably shaped gasket may be positioned between the metallic bipolar plate and the polymeric cell frame to seal their junction more securely. Because of the close structural match of the metallic bipolar plate and the polymeric cell frame, the operating stresses applied to the gasket during operation of the cell may be minimized.

In a first example aspect, there is provided an electro-synthetic or electro-energy cell utilizing at least one metallic bipolar plate with a ‘waffle’ structure or grid or grate arrangement of pits and lands, or ribs and spaces, or steps and voids, upon its face. This provides a ‘metallic waffle bipolar plate’. A ‘waffle’ structure resembles the structure present on a waffle iron. Preferably but not exclusively, the metallic bipolar plate is a metal sheet whose face has been etched, machined, stamped, formed, sunk, or otherwise fashioned into a waffle structure, i.e. a grid structure or a grate. Preferably but not exclusively, the waffle bipolar plate is sprung, to thereby comprise a ‘compressive bipolar plate’. That is, preferably but not exclusively, the waffle structure facilitates the at least one metallic bipolar plate to be a compressive component. Preferably but not exclusively, the waffle bipolar plate is created by precision industrial stamping, forming, or a similar process.

In another example aspect, a metallic electrode is directly attached to at least some or all of the lands of the waffle structure by metal-to-metal joins, for example metal-to-metal welds to some or all of the ribs or the steps of a grid structure or a grate on the face of the metallic bipolar plate. Preferably, where the waffle is a compressive bipolar plate, the above metal-to-metal joins, for example metal-to-metal welds, harness the compressive nature of the bipolar plate to exert a clamping force on the attached electrode to compress it against the inter-electrode separator.

Preferably, the above metal-to-metal joins stabilize the structure of the bipolar plate, halting, slowing, or avoiding distortions, such as ‘springback’. Optionally, the metal-to-metal joins minimize variations in the physical dimensions of the bipolar plate and its flow field, thereby allowing the use of precision industrial stamping, forming, and other manufacturing processes to produce the waffle bipolar plate.

In a further example, a metallic, porous transport layer is affixed by metal-to-metal joins, for example metal-to-metal welds, to some or all of the lands of the waffle structure of the metallic bipolar plate, wherein the other side of the metallic porous transport layer is affixed by different metal-to-metal joins, for example metal-to-metal welds, to the electrode. In a still further example, a compressive metallic porous transport layer (i.e. a metallic porous transport layer compressive component) is affixed by metal-to-metal joins, for example metal-to-metal-welds, to some or all of the lands of the waffle structure of the metallic bipolar plate, wherein the other side of the metallic porous transport layer is affixed by different metal-to-metal joins, for example metal-to-metal welds, to the electrode. Preferably, in the case where the porous transport layer is a compressive component, the above metal-to-metal joins, for example metal-to-metal welds, harness the compressive nature of the porous transport layer compressive component to exert a clamping force on the attached electrode to compress the electrode against the inter-electrode separator.

Preferably, the above metal-to-metal joins stabilize the structure of the bipolar plate, halting, slowing, or avoiding distortions, such as ‘springback’. Optionally, the metal-to-metal joins minimize variations in the physical dimensions of the bipolar plate and its flow field, thereby allowing the use of precision industrial stamping, forming, and other manufacturing processes.

Preferably, the metal-to-metal joins between the waffle metallic bipolar plate, the metallic electrode, and, where applicable, the metallic porous transport layer, provide for high electrical conductivity between these components and a uniform distribution of electrical current and voltage at the attached electrode.

Preferably, the metal-to-metal joins between the metallic waffle bipolar plate, the electrode, and, where applicable, the porous transport layer, provide for high thermal conductivity between these components and a uniform distribution of the heat produced by the cell.

In a first preferred example, a peripheral area of the metallic waffle bipolar plate (with attached electrode/porous transport layer) is attached to the polymeric cell frame via one or more polymer-to-metal joins. Preferably but not exclusively, the waffle structure, with attached electrode/porous transport layer, thus assembled, is springed (or sprung), to thereby exert an internal clamping force on the electrode within the cell, compressing it against the inter-electrode separator. Optionally, the waffle structure, with attached electrode/porous transport layer, thus assembled, is compliant, to thereby displace to accommodate a compressive force exerted by another functional component in the cell. Optionally, the one or many polymer-to-metal joins between the waffle structure with attached electrode/porous transport layer, and the polymeric cell frame partially or completely seals the cell body of the electro-synthetic or electro-energy cell.

In a second preferred example, a peripheral area of the metallic waffle bipolar plate (with attached electrode/porous transport layer) may be mechanically held tight against an area of the polymeric cell frame, by at least one polymeric ‘structural locating component’ attached to the cell frame via one or more polymer-to-polymer joins. Optionally, the tight contact seals the junction between the waffle bipolar plate and the cell frame. Optionally, a suitable gasket may be placed between the bipolar plate and the cell frame to thereby provide for an improved seal.

Optionally, the waffle structure on a metallic waffle bipolar plate in one cell is structurally complementary to the waffle structure on another metallic waffle bipolar plate of the adjacent cell in the cell stack, allowing the two waffle structures to interdigitate and mate together when they are compressed against each other. Preferably, such a structural mating assists in aligning the cells in the cell stack and diminishes the need for accurate and precise compression during the cell stack assembly and thereafter. Preferably, such a structural mating provides a higher surface area of electrical contact between cells in the cell stack.

In another example aspect, all or the majority of possible seals that can be created within a cell (i.e. the ‘intra-cell’ seals), are, preferably, formed during cell assembly. This reduces the number of reliable seals that must be formed during cell stack assembly to only or mostly those seals that are needed between cells (i.e. the ‘inter-cell’ seals). That is, the ‘cell body’ of an electro-energy or electro-synthetic cell is, preferably, sealed internally, by its components, during cell assembly. The ‘cell body’ is defined here as the portion of the cell that excludes the external liquid and gas plumbing apertures and openings (i.e. the ‘header’ or ‘manifold’ apertures or openings) that must be sealed between cells, during the formation of the cell stack (i.e. the ‘inter-cell’ seals). Preferably, the cell body is sealed by the polymer-to-polymer or polymer-to-metal joins created during cell assembly, thereby leaving only the ‘inter-cell’ liquid and/or the gas connections (outside of the ‘cell body’) to be created during assembly of the cell stack. In so doing, the process of cell stack formation may be simplified and speeded up. The need for accurate and precise compression during cell stack assembly may also be diminished.

In a first preferred example, the cell body is sealed by the metal-to-polymer joins present between the one or more metallic bipolar plates and the polymeric cell frame.

In a second preferred example, the cell body is sealed by physical contact between the one or more metallic bipolar plates and the polymeric cell frame, wherein the metallic bipolar plate is held tight up against the cell frame by the polymer-to-polymer joins between the one or more polymeric structural locating components and the polymeric cell frame. Optionally, a suitable gasket may be present between the bipolar plate and the cell frame to provide for enhanced sealing.

Whereas a direct polymer-to-metal join of the type in the first preferred example above, may be pulled apart by the differential expansions of the metal and polymer components during thermal or pressure cycling, seals that avoid a direct polymer-to-metal join of the type in the second preferred example above may be resistant to such degradation. That is, metal-to-polymer seals in which the metallic and polymeric components are physically disconnected, may provide for improved durability during repeated temperature and pressure cycling, especially in cases where the thermal and/or pressure-induced expansions of the metallic and polymeric cell components are significantly different.

Preferably, assembled electro-energy or electro-synthetic cell architectures of the above type, that suitably (pre-) position the metallic and polymeric components of the cell via polymer-to-polymer, polymer-to-metal, and/or metal-to-metal joins, may provide for simplified and reliable formation (assembly) of a cell stack. Such suitable positioning may avoid or mitigate the need to accurately position the cells and cell components during the formation of the cell stack, thereby speeding up the process and improving the reliability of cell stack assembly. Preferably, the cell architectures described above also provide for cells that can be assembled into or within cell stacks using only moderate or low compression that need not be precisely applied, facially or laterally. Preferably, the resulting cell stacks may be subsequently operated whilst maintaining only a moderate or a low compression, thereby avoiding the need for a particular, or a high compression during cell stack assembly and/or thereafter. The moderate or low compression may, preferably, be created and maintained by torsional, mechanical, hydraulic (i.e. liquid), or other means that can accommodate dimensional changes in the length of the cell stack as may occur during repeated temperature or pressure cycling. In combining suitable (pre-) positioning with the reduced need for compression, the above cell architectures preferably provide for simplified and reliable, high-speed, high-volume, industrial, assembly of the electro-energy or electro-synthetic cell into or within cell stacks that do not leak or mix the liquid or gas reactants and products, both after assembly and during subsequent operation.

In a first preferred example embodiment, there is provided electro-energy or electro-synthetic cell architectures comprising at least one polymeric cell frame, to which is attached:
at least one polymeric inter-electrode separator, by or via one or more polymer-to-polymer joins; and
at least one metallic functional component, by or via one or more polymer-to-metal joins.

Most preferably, the at least one metallic functional component is a metallic bipolar plate. Most preferably, the metallic bipolar plate forms part of a metal-to-metal joined assembly that contains at least one metallic bipolar plate and at least one metallic electrode that are joined to each other, for example, by one or more metal-to-metal welds. The metal-to-metal joined assembly may, optionally, include at least one metallic porous transport layer that is located between the at least one electrode and the at least one bipolar plate, and that is joined to one or both of them, for example, by one or more metal-to-metal welds. Metal-to-metal joins such as, for example, metal-to-metal welds may provide for reduced or unchanging electrical resistance between metallic functional materials, thereby improving the energy efficiency of the cell during operation. Most preferably, one or more polymer-to-metal joins between the polymeric cell frame and the metallic bipolar plate hold the metal-to-metal joined assembly in a suitable position within or about the cell frame. Most preferably, one or more polymer-to-metal joins between the polymeric cell frame and the metallic bipolar plate seal the polymeric cell frame to the metallic bipolar plate. In one example, the metallic bipolar plate is a compressive component, being a metallic bipolar plate compressive component.

Optionally, the at least one metallic functional component comprises a metallic electrode or a metallic porous transport layer. Optionally, the metallic electrode or the metallic porous transport layer forms part of a metal-to-metal joined assembly containing at least one metallic bipolar plate. Optionally, one or more polymer-to-metal joins between the polymeric cell frame and the metallic electrode or between the polymeric cell frame and the metallic porous transport layer hold the metal-to-metal joined assembly in a suitable position within or about the cell frame. Optionally, one or more polymer-to-metal joins between the polymeric cell frame and the metallic electrode or between the polymeric cell frame and the metallic porous transport layer seal the metal-to-metal joined assembly to the cell frame. In one example, the metallic porous transport layer is a compressive component, being a metallic porous transport layer compressive component.

In a second preferred example embodiment, there is provided electro-energy or electro-synthetic cell architectures comprising at least one polymeric cell frame, to which is attached:
at least one polymeric inter-electrode separator, by or via one or more polymer-to-polymer joins; and
at least one polymeric ‘structural locating component’, by one or more polymer-to-polymer joins, wherein the at least one polymeric structural locating component mechanically holds at least one metallic functional component in a suitable position within or about the cell frame.

Most preferably, the at least one metallic functional component comprises a metallic bipolar plate. Most preferably, the metallic bipolar plate forms part of a metal-to-metal joined assembly that contains at least one metallic bipolar plate and at least one metallic electrode that are joined to each other, for example, by one or more metal-to-metal welds. The metal-to-metal joined assembly may, optionally, include at least one metallic porous transport layer that is located between the at least one electrode and the at least one metallic bipolar plate, and that is joined to one or both of them, for example, by one or more metal-to-metal welds. Metal-to-metal joins such as, for example, metal-to-metal welds may provide for reduced or unchanging electrical resistance between metallic functional materials, thereby improving the energy efficiency of the cell during operation. Most preferably, polymer-to-polymer joins between the polymeric cell frame and the at least one polymeric structural locating component mechanically holds the metal-to-metal joined assembly in a suitable position within or about the cell frame. Most preferably, the metallic bipolar plate of the at least one metal-to-metal joined assembly is held tight up against the polymeric cell frame, thereby sealing their junction. Optionally, a suitable gasket may be present between the bipolar plate and the cell frame to thereby provide for an enhanced seal.

Optionally, the at least one metallic functional component comprises a metallic electrode or a metallic porous transport layer. Optionally, the metallic electrode or the metallic porous transport layer forms part of a metal-to-metal joined assembly containing at least one metallic bipolar plate, in a suitable position within or about the cell frame. Optionally, the at least one polymeric structural locating component mechanically also holds the at least one metal-to-metal joined assembly in a suitable position within or about the cell frame.

Turning now to the header/manifold apertures and openings in electro-synthetic or electro-energy cells that can only be sealed when a multicity of cells are combined into a single cell stack; i.e. the ‘inter-cell’ seals that must be made outside of the ‘cell body’ during stack assembly. In a further aspect, such header/manifold apertures and openings are sealed by one or more polymer-to-polymer joins to the equivalent header/manifold apertures and openings of the next cell in the stack. That is, ‘inter-cell’ polymer-to-polymer seals may be used during cell stack formation to completely seal a cell, whose ‘cell body’ has already been sealed during cell (pre-) assembly. In other words, cells may be fully sealed during cell stack formation by creating polymer-to-polymer joins between the liquid and/or the gas connections into and out of the remaining cells in the cell stack during cell stack formation.

Such ‘inter-cell’ polymer-to-polymer joins may further diminish the challenge of creating seals by accurate and precise compression during cell stack formation. They may also provide for more reliable seals that are less reliant on the maintenance of invariant, high compression across the cell stack. By contrast, conventional cell stacks rely, essentially entirely, on high compression to create and maintain such seals.

Any polymer-to-polymer joining technique may be used to create the needed joins, including any of the polymer-to-polymer joining techniques described or listed in this specification.

In a particularly preferred example, such polymer-to-polymer joins are created by patterning and placing a resistive metal wire or electrical circuit around the polymeric header/manifold apertures to be sealed on each cell. After the cells are stacked for cell assembly and compressed to the extent required, an electrical current is passed through each of the circuits present, causing heating of each circuit, resulting in melting, and fusion of the polymeric materials of the adjacent cells about the circuit. The resulting cell stack architecture comprises cells stacked and joined together via polymer-to-polymer joins that incorporate resistive wires and/or electrical circuits about the header/manifold apertures.

In another preferred example, a gasket, such as a shaped sheet or ring of rubber is placed around a first portion of the polymeric regions to be sealed, followed by polymer-to-polymer sealing of the type described above in a second portion of the polymeric regions to be sealed. The gasket may provide an additional, long-term defence against leaking that may be especially useful where structurally complex polymer-to-polymer joining is needed. The resulting cell stack architecture comprises cells stacked and joined together via polymer-to-polymer joins that incorporate resistive wires and/or electrical circuits, with gaskets near to the polymer-to-polymer join, about the header/manifold apertures.

In other examples, the polymer-to-polymer joining required may be too complex or demanding to seal reliably, in which case one or more gaskets may be used and relied upon. The resulting cell stack architecture comprises cells stacked, with gaskets about the header/manifold apertures, wherein compression of the stack maintains the gasket seals.

Preferably, the sealing architectures described above provide for simplified and reliable assembly of components and cells into or within cell stacks that do not leak or mix the liquid or gas reactants and products, both after assembly and during subsequent operation. Preferably, they also provide for high-speed, high-volume, industrial assembly of electro-synthetic or electro-energy cell stacks.

In an example aspect, the overall compression pressure applied to the cell stack during assembly and thereafter, such as during electrochemical operation, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, greater than 20 bar, greater than 30 bar, greater than 40 bar, greater than 50 bar, or greater than 100 bar.

In various other example aspects, embodiments relate to the reliable and successful assembly of electro-energy or electro-synthetic cells and cell stacks when components with low tolerances are used. The resulting cells and cell stacks preferably do not leak or mix the liquid or gas reactants and products, both after assembly and during subsequent operation.

Preferably, metal-to-polymer or polymer-to-polymer joins of the types described above incorporate one or more ‘tolerance compensation features’ that adjust for low tolerances and high variability in the dimensions of cell components, including polymeric cell frames, inter-electrode separators, electrodes, porous transport layers, or bipolar plates. Tolerance compensation features include structures that are designed to accommodate variability in the components being joined. They include channels, grooves, slots, tongues, and other structural features that are slightly over-sized or slightly under-sized to thereby accommodate variations in the quantity of materials released during joining. Some tolerance compensation features may be incorporated in the form of positive engagement components, such as tongue-and-groove joints, locating pins and wells, and the like.

In various other example aspects, embodiments relate to the polymer-to-polymer, polymer-to-metal, and metal-to-metal joins that may be used in the above cell and cell stack architectures and techniques. In some examples, such joins incorporate one or more ‘tolerance compensation features’. ‘Tolerance compensation features’ accommodate low tolerances and high variability in the dimensions of cell components, including polymeric cell frames, inter-electrode separators, electrodes, compressive components, porous transport layers, or bipolar plates. Preferably, but not exclusively, the following joins that may incorporate tolerance compensation features may be used:
(1) ‘sealed wire welding’ joins
(2) ‘ridged polymer-to-metal’ joins

In various other example aspects, embodiments relate to the polymer-to-polymer and polymer-to-metal joins that may be used in the above cell and cell stack architectures and techniques.

Preferably, but not exclusively, the following polymer-to-metal joins may be used in the above cell and cell stack architectures and techniques:
(1) ‘continuous edge heat staked’ joins,
(2) ‘textured metal to polymer’ joins,
(3) ‘roll formed’ joins.

Other preferred example embodiments include but are not limited to, polymer-to-metal and polymer-to-polymer joins involving:
(1) Chemical binding, with or without chemical adhesion promoting materials, including the application of:
   i. Adhesives and glues of various types, including but not limited to
      1. Adhesives by chemical composition, including: epoxy adhesives, polyurethane adhesives, polyimide adhesives, cyanoacrylate adhesives, polyvinylacetate glue,
      2. Adhesives by physical form, including: adhesive pastes, adhesive gums, adhesive films, adhesive cements, adhesive resins, adhesive bonding agents, elastomeric adhesives, wet adhesives,
      3. Adhesives by classification, including: contact adhesives, reactive adhesives, single-component reactive adhesives, two- or multi-component reactive adhesives, hot-melt adhesives, pressure-sensitive adhesives, thermosetting adhesives,
      4. Adhesives by load-bearing capability, including: structural adhesives, non-structural adhesives, semi-structural adhesives;
(2) Polymer dissolution and re-materialisation, including but not limited to
   i. Solvent welding;
(3) Polymer melting or softening, with or without use of wetting agents that facilitate polymer flow, including but not limited to
   i. Thermal welding,
   ii. Hot plate or platen welding,
   iii. Ultrasonic or vibration welding,
   iv. Laser or laser beam welding,
   v. Hot gas welding,
   vi. Spin welding,
   vii. Friction welding,
   viii. Frequency, or high-frequency, or radio-frequency welding,
   ix. Infra-red or non-contact welding,
   x. Speed tip welding,
   xi. Extrusion welding,
   xii. Contact welding,
   xiii. Induction welding, and
   xiv. Injection welding.

In various other example aspects, embodiments relate to the metal-to-metal joins that may be used in the above cell and cell stack architectures and techniques. Preferred example embodiments include but are not limited to, metal-to-metal joins involving:
(1) Mechanical joins, including but not limited to joins formed by
   i. Riveting,
   ii. Caulking,
   iii. Bolting,
   iv. Shrink fitting,
   v. Folding;
(2) Chemical joins, including but not limited to joins formed by
   i. Bonding, including bonding metals with glues including electrically conductive glues;
(3) Metallurgical joins, including but not limited to joins formed by
   i. Fusion welding, including:
      1. Electrical energy: Arc welding, electron beam welding,
      2. Chemical energy: gas welding,
      3. Light energy: Laser welding;
   ii. Pressure welding, including:
      1. Electrical energy: resistance welding, including resistance spot welding, projection welding, seam welding, upset welding, flash welding,
      2. Chemical energy: explosion welding,
      3. Mechanical energy: cold pressure welding, friction welding, friction stir welding, ultrasonic welding, diffusion welding;
   iii. Brazing/soldering, including:
      1. Electrical energy: Induction heating brazing, soft brazing, soldering,
      2. Chemical energy: torch brazing, flame brazing,
      3. Light energy: light beam brazing, laser brazing,
      4. ‘Soft soldering’,
      5. ‘Hard soldering’.

Preferably but not exclusively, the liquid electrolyte used in example embodiments comprises a hydroxide salt and has a pH of at least 10. Optionally, the liquid electrolyte used in example embodiments has a pH of less than 10.

Preferably, cells and cell stacks with the above features are electro-energy or electro-synthetic cells or cell stacks, such as: (i) hydrogen-oxygen fuel cells, including Polymer Electrolyte Membrane (PEM) fuel cells or Alkaline fuel cells, (ii) direct alcohol fuel cells, including direct methanol or direct ethanol fuel cells, (iii) phosphoric acid fuel cells, or (iv) ammonia fuel cells.

Preferably, cells and cell stacks with the above features are electro-synthetic cells or cell stacks, such as: (i) water electrolysers, (ii) chlor-alkali electrolyzers, (iii) nitrogen reductions cells for ammonia manufacture, or (iv) CO₂ electrolysers, including combined carbon capture and CO₂ electrolysers.

Preferably, cells and cell stacks with the above features are capillary-fed electro-energy or electro-synthetic cells or cell stacks, of the type described in International Patent Publication Nos. WO2022056603, WO2022056604, WO2022056605, and WO2022056606, which are hereby incorporated by reference.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 schematically depicts the assembly of a preferred example embodiment cell.

FIG. 2 schematically depicts the assembly of another preferred example embodiment cell.

FIG. 3 schematically depicts the assembly of a further preferred example embodiment cell.

FIG. 4 depicts the attachment of an example electrode to an example waffle bipolar plate via metal-to-metal joins.

FIG. 5 depicts assembly of an example cell stack.

FIG. 6 depicts how two cells in a cell stack may be sealed together using a heating wire.

FIG. 7 schematically depicts in cross-sectional form, the assembly of a second example embodiment cell and cell stack in which the metallic components are physically disconnected to the polymeric components.

FIG. 8 schematically depicts, in cross-section, the creation of a preferred polymer-to-metal join that incorporates a tolerance compensation feature, known as a ‘sealed wire welding’ join.

FIG. 9 schematically depicts, in cross-section, a preferred polymer-to-metal join that incorporates a tolerance compensation feature, known as a ‘ridged polymer-to-metal’ join.

FIG. 10 schematically depicts, in cross-section, the creation of a preferred polymer-to-metal join known as a ‘continuous edge heat stacked’.

FIG. 11 schematically depicts, in cross-section, the creation of a preferred polymer-to-metal join, involving the use of laser welding.

FIG. 12 schematically depicts, in cross-section, the creation of a preferred polymer-to-metal join, known as a ‘roll formed’ join.

### DETAILED DESCRIPTION

The following modes, features or aspects, given by way of example only, are described to provide a more precise understanding of the subject matter of a preferred embodiment or embodiments.

### Definitions

A ‘reactant’ is a chemical material that is consumed during an electrochemical reaction.

A ‘product’ is a chemical material that is produced during an electrochemical reaction.

An ‘electrolyte’ is a liquid containing dissolved ions that has the capacity to conduct electricity.

‘Room temperature’ is defined as 21° C.

In the context of a manufactured part, the term ‘tolerance’ refers to the allowable amount of variation in the dimensions of the part. ‘High’ tolerance is correlated to high precision—i.e. it indicates a small variation in the dimensions of the manufactured part. ‘Low’ tolerance correlates with low precision—i.e. it indicates a large variation in the dimensions of the manufactured part.

In the context of the present specification, the term ‘join’, ‘joined’ or ‘joins’ refers to a secure physical attachment, such as a weld, a fusion, a bonding, an adhesion, a blending, a melding, or a merging of two structures. For example, a ‘polymer-to-polymer’ join refers to a secure physical attachment between two polymeric structures. A ‘polymer-to-metal’ join refers to a secure physical attachment between a polymeric structure and a metallic structure.

A ‘liquid-gas’ cell is defined as an electrochemical cell that has at least one liquid-phase reactant or product, and at least one gas-phase reactant or product.

An ‘electro-energy cell’ is an electrochemical cell that generates electrical power continually or continuously, during operation, over indefinite periods of time, for use outside of the cell. Electro-energy cells may require a constant external supply of reactants during operation. The products of the electrochemical reaction may also be constantly removed from such cells during operation. An electro-energy cell may be a liquid-gas cell. An example of an electro-energy cell is a hydrogen-oxygen fuel cell. This example is also a liquid-gas cell.

An ‘electro-synthetic cell’ is an electrochemical cell that manufactures one or more chemical materials continually or continuously, during operation, over indefinite periods of time, for use outside the cell. The chemical materials may be in the form of a gas, liquid, or solid. Like an electro-energy cell, an electro-synthetic cell may also require a constant supply of reactants and a constant removal of products during operation. Electro-synthetic cells may generally further require a constant input of electrical energy during operation. An electro-synthetic cell may be a liquid-gas cell. An example of an electro-synthetic cell is a water electrolysis cell. This example is also a liquid-gas cell.

Electro-energy and electro-synthetic cells differ from other types of electrochemical cells, such as batteries, sensors and the like, in that they do not incorporate within the cell body all/some of the reactants they require to operate, nor all/some of the products they generate during operation. These may be, instead, constantly brought in from, or removed to the outside of the cell during operation. For example, electro-energy cells are distinguished from galvanic cells in that galvanic cells store their reactants and products within the cell body. Unlike a battery, an electro-energy cell does not store chemical or electrical energy within it. Similarly, while some electrochemical sensors may consume reactants and generate products in limited quantities during the sensing operation, all/some of these are stored within the cell body itself.

An ‘inter-electrode separator’ is defined as a structure within an electro-energy and electro-synthetic cell that is ion-permeable but largely impermeable to gas, and that is placed between the electrodes in an electro-synthetic or electro-energy cell to prevent gas from one of the component half cells crossing over into the other half-cell. Examples of ‘inter-electrode separators’ include ion-permeable membranes (e.g. Nafion 117 and Nafion 115, manufactured by the Du Pont Nemours company), diaphragms (e.g. Zirfon PERL, manufactured by Agfa), fabrics (e.g. various asbestos fabrics used in the past), or similar structures. The term ‘inter-electrode separator’ includes an inter-electrode porous capillary separator, is defined as stated in International Patent Publication Nos. WO2022056603, WO2022056604, WO2022056605, and WO2022056606, which are hereby incorporated by reference.

An ‘electrode’ is a conductive structure, typically metallic, at which electrons are converted to ions, or vice versa, within an electro-synthetic or electro-energy cell. An electrode may typically be an anode or a cathode during operation of the cell.

A ‘porous transport layer’ is a porous layer that contains voids through which gas or liquid passes during operation of an electro-synthetic or electro-energy cell. A porous transport layer may be conducting and/or metallic and/or located close to or abutting an electrode. A porous transport layer may also be located between an electrode and a bipolar plate. That is, a porous transport layer may be a conductive, often metallic structure that is porous to liquid and/or gaseous fluids, and that lies between an electrode and its bipolar plate. A porous transport layer may provide an electrical connection between the electrode and the bipolar plate, whilst simultaneously allowing for movement of liquid or gas to or from the electrode.

A ‘bipolar plate’ is a conducting plate, usually metallic, that is located on the outside of an electro-synthetic or electro-energy cell, or between electro-synthetic or electro-energy cells in a cell stack. The term ‘bipolar’ refers to the fact that, within a cell stack, the voltage applied to a bipolar plate may be used on one side in an anode reaction and on the other side in a cathode reaction. The primary function of a bipolar plate is to accumulate and uniformly distribute an electrical current from one cell to the next.

A ‘flow field’ is a pattern of pits and lands, or ribs and spaces, or steps and voids etched, machined, stamped, sunk, or otherwise formed on the face of a bipolar plate. A common flow field is a serpentine flow field, which has one or more channels in a serpentine arrangement sunk into their face.

A ‘waffle’ flow field is a pattern of pits and lands, or ribs and spaces, or steps and voids, reminiscent of that in a waffle iron.

A ‘waffle bipolar plate’ is a bipolar plate that has a ‘waffle’ flow field present on its face. That is, its flow field resembles that of a waffle-iron. It is to be understood that the term ‘waffle bipolar plate’ may be used herein to describe any bipolar plate that can simultaneously function as a porous transport layer. That is, the term ‘waffle bipolar plate’ is used herein to also describe any bipolar plate whose face contains voids through which gas may passes during operation of an electro-synthetic or electro-energy cell. Put another way: the term ‘waffle bipolar plate’ may be used herein to describe any bipolar plate that provides porosity of the type also found in a porous transport layer.

A ‘cell stack’ or a ‘stack’ is a collection of electrochemical cells stacked laterally, one after the other, such that they are connected in electrical series. A cell stack may be designed to accumulate the reactants and products involved in their constituent cells into single, external product and/or reactant streams, that are more easily managed than multiple smaller streams.

Cell stacks may take the form of a ‘filter-press’ arrangement, which is defined as a cell stack wherein the cells are compressed together between endplates during its assembly and/or operation.

An ‘endplate’ is defined as a rigid, essentially incompressible, essentially flat structure that is used at the ends of a ‘filter-press’ cell stack and between which the cells in the cell stack are compressed.

An assembled cell is defined as being ‘internally compressed’ if a clamping force is imparted to at least one electrode within the assembled cell, compressing the electrode against the inter-electrode separator. In preferred embodiments, individual cells are, preferably, assembled prior to being combined in cell stacks. Preferably, such assembled cells are ‘internally compressed’, meaning that a clamping force is already imparted to at least one electrode within the assembled cell, compressing the electrode against the inter-electrode separator. Combining such (pre-) assembled cells into a cell stack may be considerable easier and more quickly achieved than when cells are only assembled during the cell stack formation process itself, as may be conventionally done for electro-synthetic or electro-energy filter press cell stacks. Moreover, the need for accurate and precise compression of the cell stack during its formation and thereafter, may be diminished by the fact that the cells in the stack are already “internally compressed”.

A ‘header aperture’ or ‘header opening’ is an external aperture or opening in an individual cell, for conveying a liquid or gas fluid into or out of the cell. When combined with the equivalent header aperture in other cells in the stack, the header aperture or opening forms the corresponding ‘header’ in the cell stack.

A ‘header’ is a channel, a tube, a chamber, or a trough formed by the combination of header apertures or openings in the individual cells in a cell stack, for conveying a liquid or gas fluid through the full thickness of a cell stack. A header is formed when a set of equivalent header apertures or openings in multiple cells line up and seal when the cells are compressed together to form the cell stack.

A ‘manifold’ is one or more pipes, tubes, chambers, or channels with multiple openings, for conveying a fluid. Within a cell stack, a header may also be a manifold.

The term ‘cell body’ is defined as the portion of a cell outside of the external openings for conveying liquid or gas fluids into or out of the cell; that is, it is the portion of a cell excluding the header/manifold apertures or openings. That is, it is the portion of the cell that can be sealed by ‘intra-cell’ seals (i.e. seals that involve and can be created within only a single cell) and excludes the portion of the cell that can only be sealed by ‘inter-cell’ seals (i.e. seals that necessarily involve two or more cells).

A cell is ‘stackable’ if it is designed to be deployed in a cell stack. For example, in the case of a filter-press-type cell stack, it may contain liquid or gas plumbing header apertures or openings that interface with the equivalent apertures or openings in other cells in the stack to form headers or manifolds. In the non-limiting example of a filter-press cell stack, the cells are substantially flat and compressed against each other between endplates during its assembly and/or operation.

A ‘structural locating component’ is defined as a polymeric structure in an electro-synthetic or electro-energy cell that, when attached to a polymeric cell frame, mechanically holds a physically disconnected metallic structure in a suitable position within or about the cell and/or cell frame.

A ‘compressive component’ or ‘compressive element’ in a cell is defined as a springed or sprung structure that, when suitably positioned in the cell, exerts a clamping force on at least one of the electrodes, compressing it against the inter-electrode separator. Preferably, the springed or sprung action is created within at least one of a metallic bipolar plate or a metallic porous transport layer. Optionally, the springed or sprung action may be created within at least one metallic electrode.

A ‘bipolar plate compressive component’ is a bipolar plate that also has a compressive function. That is, the bipolar plate is a springed or sprung structure that, when suitably positioned in an assembled cell, exerts a clamping force on its associated electrode, compressing the electrode against the inter-electrode separator. It is to be understood that such a springed action is, preferably, designed into the bipolar plate compressive component so that it imparts a specific, pre-determined clamping force, within a relatively narrow range of clamping forces, to the electrode. The bipolar plate compressive component does not impart a clamping force merely adventitiously or in an uncontrolled or non-repeatable manner, for example due to ‘springback’. Preferably, the clamping force within the cell is created, fully or partially, by the rigidity of: (1) a polymer-to-metal join between the bipolar plate compressive component and the polymeric cell frame, or (2) a polymer-to-polymer join between a ‘polymeric structural locating’ element and the polymeric cell frame.

A ‘porous transport layer compressive component’ or a ‘springed porous transport layer’ is a porous transport layer that also has a compressive function. That is, the porous transport layer is a springed or sprung structure that, when suitably positioned in an assembled cell, exerts a clamping force on its associated electrode, compressing the electrode against the inter-electrode separator. It is to be understood that such a springed action is, preferably, designed into the porous transport layer compressive component so that it imparts a specific, pre-determined clamping force, within a relatively narrow range of clamping forces, to the electrode. The porous transport layer compressive component does not impart a clamping force merely adventitiously or in an uncontrolled or non-repeatable manner. Preferably, the clamping force within the cell is created, fully or partially, by the rigidity of: (1) a polymer-to-metal join between the bipolar plate compressive component and the polymeric cell frame, or (2) a polymer-to-polymer join between a ‘polymeric structural locating’ element and the polymeric cell frame.

There can be provided different compressive components, for example, a ‘metallic bipolar plate compressive component’, a ‘metallic porous transport layer compressive component’, and/or a ‘metallic electrode compressive component’. Such structures are metallic structures that are springed or sprung structures that, when suitably positioned in an assembled cell, they exert a clamping force on the associated electrode, compressing it against the inter-electrode separator.

A ‘compliant component’ or a ‘compliant element’ in a cell is defined as a compressible structure that, when suitably positioned in the cell, displaces to accommodate, and uniformly distribute a compressive force. Preferably, the compliance action is created within at least one of a metallic bipolar plate or a metallic porous transport layer. Optionally, the compliance action may be created within at least one metallic electrode. A ‘bipolar plate compliant component’ is a bipolar plate that also has a compliant function. A ‘porous transport layer compliant component’ is a porous transport layer that also has a compliant function. That is, there can be provided different compliant components, for example, a ‘metallic bipolar plate compliant component’, a ‘metallic porous transport layer compliant component’, and/or a ‘metallic electrode compliant component’.

A ‘metal-to-metal weld’ as used herein is defined to be any form of metallurgical metal-to-metal join that may be considered to involve a weld, including but not limited to fusion welding and pressure welding.

A ‘gasket’ is defined as a shaped sheet or ring of rubber or other elastic material that seals the junction between two surfaces that are not physically joined together.

A ‘tolerance compensation feature’ is defined as a structure that is designed to accommodate variability in the components being joined. Tolerance compensation features include but are not exclusive to channels, grooves, slots, tongues, and other structural features that are slightly over-sized or slightly under-sized to thereby accommodate variations in the quantity of materials that flow during joining.

A ‘positive engagement component’ is a complementary structure that promotes engagement between two surfaces, such as a tongue-and-groove joint, a locating pin and well, and the like. Some positive engagement components may include one or more tolerance compensation features.

### PREFERRED EMBODIMENTS

The inventors have developed new electro-synthetic or electro-energy cell architectures that simplify the process of reliably assembling cells into cell stacks and maintaining them during subsequent operation. The cells comprise of polymeric cell frames that incorporate within them or about them, functional materials, such as an inter-electrode separator, electrodes, porous transport layers, and bipolar plates. The individual functional materials may be attached to the cell frame by polymer-to-polymer or polymer-to-metal joins. In one example, one or more polymeric functional materials may be attached to a polymeric cell frame via one or more polymer-to-polymer joins. For example, a polymeric inter-electrode separator may be attached to a polymeric cell frame via one or more polymer-to-polymer joins. The polymer-to-polymer joins may seal the junction between the polymeric inter-electrode separator and the polymeric cell frame to, for example, leaks of gas from one side of the inter-electrode separator to the other, across the thickness of the inter-electrode separator. In another example, one or more metallic functional materials may be attached to a polymeric cell frame via one or more metal-to-polymer joins. For example, a metallic bipolar plate may be attached to the cell frame via one or more polymer-to-metal joins. The polymer-to-metal joins may seal the junction between the metallic bipolar plate and the polymeric cell frame to, for example, leaks of liquid or gas to or from the outside of the cell.

Some or all of the metallic functional materials for each half-cell within the overall cell may, further, be attached to each other via one or more metal-to-metal joins, for example metal-to-metal welds. For example, a metallic electrode and a metallic bipolar plate, comprising metallic components of a single half-cell, may be attached to each other via one or more metal-to-metal joins, for example metal-to-metal welds. In an alternative example, a metallic electrode, a metallic porous transport layer, and a metallic bipolar plate, comprising metallic components of a single half-cell, may be attached to each other via one or more metal-to-metal joins, for example metal-to-metal welds. Such metal-to-metal joins, for example metal-to-metal welds, may thereby create a single metallic component to be handled during assembly of the cell, simplifying the cell assembly. Moreover, such metal-to-metal joining processes may be carried out separately and independently of cell assembly, again simplifying cell assembly.

One or more of the metallic functional materials thus attached to each other, may be attached to the polymeric cell frame via one or more metal-to-polymer joins. For example, the bipolar plate in one of the aforementioned metal-to-metal joined assemblies may be attached to the polymeric cell frame by one or more metal-to-polymer joins. The metal-to-polymer joins may seal the junction between the metallic bipolar plate and the polymeric cell frame to, for example, leaks of liquid or gas to or from the outside of the cell.

In an alternative embodiment, a polymeric ‘structural locating component’ may be attached to the polymeric cell frame via one or more polymer-to-polymer joins to, thereby, structurally constrain some or all of the metallic functional components to suitable positions within or about the cell frame. A structural locating component is a polymeric structure that, when attached to the polymeric cell frame, mechanically holds one or more physically disconnected metallic components in a suitable position within or about the cell frame. In such a case, the metallic functional components may not be physically joined to the polymeric cell frame. Some of the metallic functional components, such as, for example, a bipolar plate may, nevertheless, be positioned tight up against or very close to the polymeric cell frame. They may be positioned so tightly that the junction is sealed to, for example, leaks of liquid or gas to or from the outside of the cell. Alternatively, a suitably shaped gasket may be positioned between the metallic bipolar plate and the polymeric cell frame to seal their junction more securely. Because of the close structural match of the metallic bipolar plate and the polymeric cell frame, the operating stresses applied to the gasket during operation of the cell may be minimized.

Cell architectures of this type may also be partially self-sealed. For example, by virtue of the sealing characteristics described above, the ‘cell body’ of such an electro-energy or electro-synthetic cell architectures may be sealed internally, by its components, thereby diminishing the need to create reliable seals by accurately and precisely compressing the cell stack during its assembly and thereafter. The ‘cell body’ is that portion of a cell that excludes the external liquid and gas plumbing apertures and openings; that is, it is that part of the cell outside of the ‘header’ or ‘manifold’ apertures or openings. Put another way, the ‘cell body’ is the portion of the cell that can be sealed by ‘intra-cell’ seals (i.e. seals that involve and can be created by the cell components within a single cell) and excludes the portion of the cell that can only be sealed by inter-cell’ seals (i.e. seals that necessarily bridge two or more cells). Preferably, the cell body is, effectively, sealed by the presence of the cell components and the polymer-to-polymer or polymer-to-metal joins present, leaving only the ‘inter-cell’ liquid and/or the gas connections to be created during assembly of the cell stack. That is, the cell body may be sealed by the metal-to-polymer joins present between the one or more metallic bipolar plates and the polymeric cell frame. Alternatively, the cell body may be sealed by physical contact between the one or more metallic bipolar plates and the polymeric cell frame, wherein the metallic bipolar plate is held tight up against the cell frame by the polymer-to-polymer joins between the one or more polymeric structural locating components and the polymeric cell frame. Optionally, a suitable gasket may be present between the bipolar plate and the cell frame to provide for enhanced sealing. Whereas a direct polymer-to-metal join of the former type may be pulled apart by the forces created by the differential expansions of the metal and polymer components during thermal or pressure cycling, seals that avoid a direct polymer-to-metal join of the latter type may be resistant to such degradation. That is, metal-to-polymer seals in which the metallic and polymeric components are physically disconnected, may provide for improved durability during repeated temperature and pressure cycling, especially in cases where the thermal and/or pressure-induced expansions of the metallic and polymeric cell components are significantly different.

Electro-energy or electro-synthetic cell architectures of the above types may also be ‘internally compressed’, to thereby diminish the need to compress the cell stack accurately and precisely during its assembly and thereafter. That is, the architecture of the assembled cell may exert a clamping force on at least one of the electrodes, compressing it against the inter-electrode separator.

This may be achieved by incorporation in the cell architecture, of at least one compressive component (for example a springed component or element, or a sprung component or element) that exerts a clamping force on at least one of the electrodes (e.g.

a first electrode or a second electrode), compressing it against the inter-electrode separator. The at least one compressive component, e.g. a springed component or a sprung component, may comprise a metallic bipolar plate or a metallic porous transport layer. Alternatively, but less favourably, the at least one compressive component may comprise a metallic electrode.

Preferably, the clamping force applied internally within an assembled cell, by a compressive component upon an electrode, compressing the electrode against the inter-electrode separator, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.

The compression applied internally within an assembled cell may, preferably, be greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.

To mediate and uniformly distribute the internal compressive forces, the cells may further incorporate at least one compliant component. Such a compliant component may uniformly displace to accommodate the compressive force exerted by the at least one at least one compressive component. The compliant component may be a metallic bipolar plate, a metallic porous transport layer, or a metallic electrode.

Electro-energy or electro-synthetic cell architectures of the above type, that suitably position the metallic and polymeric components in a (pre-) assembled cell via polymer-to-polymer, polymer-to-metal, and/or metal-to-metal joins, may provide for simplified and reliable assembly of a cell stack. Such suitable positioning in the assembled cell may avoid or mitigate the need to accurately position the cell components in the cell stack during the formation of the cell stack. The cell architectures described above may also provide for assembled cells to be combined into or within cell stacks using only moderate or low compression that need not be precisely applied, facially or laterally. Moreover, the resulting cell stacks may be subsequently operated whilst maintaining only a moderate or a low compression, thereby avoiding the need for a particular, or high compression after cell stack formation. The moderate or low compression may be created and maintained by torsional, mechanical, hydraulic (i.e. liquid), or other means that can accommodate dimensional changes in the length of the cell stack as may occur during repeated temperature or pressure cycling. Accordingly, in combining suitable positioning in an assembled cell with the reduced need for compression, the above cell architectures may provide for simplified and reliable, high-speed, high-volume, industrial formation of electro-energy or electro-synthetic cell stacks, particularly filter-press cell stacks, that do not leak or mix the liquid or gas reactants and products, both after assembly and during subsequent operation.

### Example Preferred Embodiments: A First Preferred Example Embodiment Cell Architecture

In a first preferred, non-limiting, example embodiment, there is provided electro-energy or electro-synthetic cell architectures comprising at least one polymeric cell frame, to which is attached:
at least one polymeric inter-electrode separator, by or via one or more polymer-to-polymer joins; and
at least one metallic functional component, by or via one or more polymer-to-metal joins.

The at least one metallic functional component may be a metallic bipolar plate. The metallic bipolar plate may form part of a metal-to-metal joined assembly, for example a metal-to-metal welded assembly, that, for example, includes at least one metallic bipolar plate and at least one metallic electrode, for example a cathode or an anode, as well as, optionally, at least one metallic porous transport layer. One or more polymer-to-metal joins between the polymeric cell frame and the metallic bipolar plate may hold the metal-to-metal joined assembly in a suitable position within or about the cell frame. The presence of the one or more polymer-to-metal joins may seal the polymeric cell frame to the metallic bipolar plate.

The at least one metallic functional component may, alternatively, comprise a metallic electrode or a metallic porous transport layer. The at least one metallic electrode or the at least one metallic porous transport layer may also form part of a metal-to-metal joined assembly, for example a metal-to-metal welded assembly, containing at least one metallic bipolar plate. Optionally, one or more polymer-to-metal joins between the polymeric cell frame and the metallic electrode or between the polymeric cell frame and the metallic porous transport layer may hold the metal-to-metal joined assembly in a suitable position within or about the cell frame.

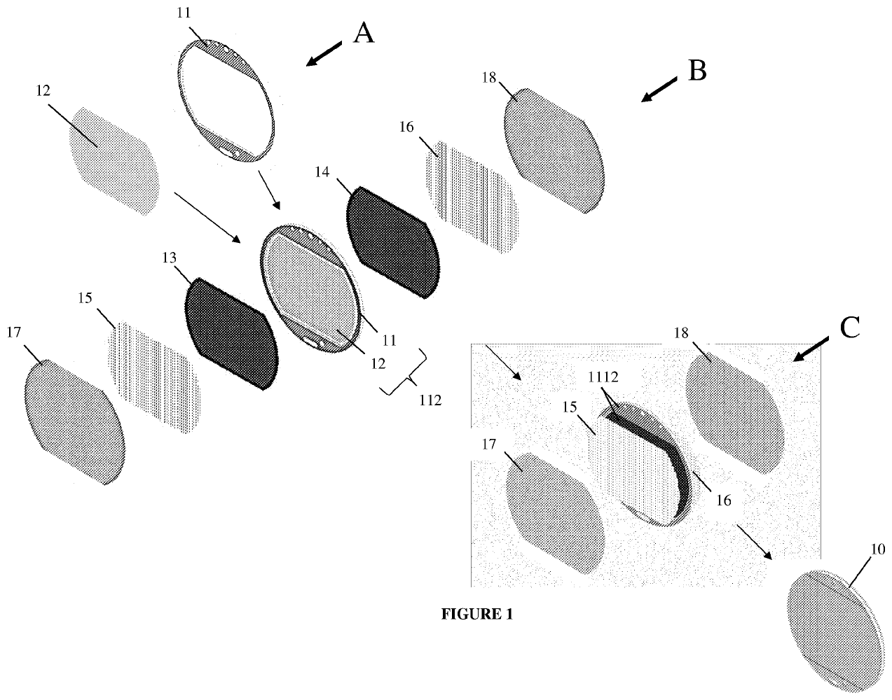

FIG. 1 schematically depicts the components of, and assembly of a first preferred example embodiment electro-energy or electro-synthetic cell 10. Starting at the top left of FIG. 1 along row A, the cell comprises of a polymeric cell frame 11 having a relatively large, open window in its centre (i.e. a window cut-out), and an inter-electrode separator 12. In one example, the base material of the inter-electrode separator is a polymeric material, that is the inter-electrode separator is a polymeric inter-electrode separator. Preferably but not exclusively, the base material of the inter-electrode separator comprises the same or a substantially similar polymeric material to the base material of construction of the cell frame 11. The window cut-out is preferably a space devoid of material. However, in some examples material may be present, for example ribs or supports, for example of polymeric material, may be present and may span parts of the cut-out window area for structural integrity of the polymeric cell frame or for support of other components.

Row B in FIG. 1 shows the inter-electrode separator 12 joined to the cell frame 11 by a polymer-to-polymer join around the periphery of the window cut out in cell frame 12, forming the assembly 112. The inter-electrode separator 12 is joined to the polymeric cell frame 11 and positioned in the window cut-out. Other components in the exploded view shown along row B in FIG. 1 include the first electrode 13 and the second electrode 14 (i.e. the electrodes 13, 14 or two electrodes 13, 14), which may be porous and may comprise a metallic base or be wholly metallic. Depending on the specific example, first electrode 13 may be an anode or a cathode, and second electrode 14 may be an anode or a cathode. The electrodes 13 and 14 are pre-cut to fit in the window of the cell frame 11, that is electrodes 13 and 14 are positioned in the polymeric cell frame. On the outside of and adjacent to the electrodes 13 and 14 are first compressive component 15 and second compressive component 16, respectively, (i.e. compressive components 15, 16) that in this particular non-limiting example are conducting, metallic, porous transport layers, that also perform a compressive (e.g. springed) function. The compressive component 15 is positioned adjacent to, or next to or abutting, the first electrode 13 on the opposite side to the inter-electrode separator 12. The compressive component 16 is positioned adjacent to, or next to or abutting, the second electrode 14 on the opposite side to the inter-electrode separator 12. The compressive components 15, 16 (also termed the metallic porous transport layer compressive components 15, 16 in this example) are also cut to fit the cut out window of cell frame 11. On the outsides of the exploded view at row B in FIG. 1 are first metallic bipolar plate 17 and second metallic bipolar plate 18 (i.e. metallic bipolar plates 17, 18). The metallic bipolar plates 17, 18 have been pre-cut to be larger than the cut out window of polymeric cell frame 11 and to therefore overlap the outside of the polymeric cell frame 11, including overlap at the top, bottom and side edges of the polymeric cell frame 11.

Row C in FIG. 1 depicts the components of and next stage in the assembly. The electrodes 13 and 14 are placed within the window cut out of cell frame 11 and located tight up against opposite sides of the inter-electrode separator 12 that has been joined to the cell frame 11. The assembly of cell frame 11, inter-electrode separator 12 and electrodes 13 and 14 is labelled as assembly 1112.

As can be seen in FIG. 1 in row C, the compressive components 15, 16 (e.g. springed porous transport layers 15 and 16) are about to be inserted into the cut out window of cell frame 11. Thereafter, the metallic bipolar plates 17 and 18 are securely attached by polymer-to-metal joins to the uncovered, exposed polymer surfaces at the top, bottom and around the sides of the cell frame 11, on its front and the back respectively, to thereby seal the ‘cell body’ of cell 10. In attaching the metallic bipolar plates 17 and 18 to the polymeric cell frame 11 by polymer-to-metal joins, the compressive components 15, 16 (e.g. springed porous transport layers 15 and 16) located between the metallic bipolar plates 17 and 18 and the electrodes 13 and 14, internally exert a clamping force on the electrodes 13 and 14, respectively, compressing the electrodes 13 and 14 tightly against opposite sides of the inter-electrode separator 12.

Thus, FIG. 1 illustrates a non-limiting example of an electro-energy or electro-synthetic cell 10 comprising a polymeric cell frame 11 and a first electrode 13 and a second electrode 14. An inter-electrode separator 12 is positioned between the first electrode 13 and the second electrode 14. A (first) compressive component 15, being a metallic porous transport layer compressive component 15, is positioned adjacent to the first electrode 13 on the opposite side to the inter-electrode separator 12. A (first) metallic bipolar plate 17 is positioned adjacent to the (first) compressive component 15 on the opposite side to the first electrode 13. In the example illustrated, which may not always be necessary in various other examples, a second compressive component 16, being a second metallic porous transport layer compressive component 16, is positioned adjacent to, next to or abutting the second electrode 14 on the opposite side to the inter-electrode separator 12, and a second metallic bipolar plate 18 is positioned adjacent to the second compressive component 16 on the opposite side to the second electrode 14. Optionally, at least one polymeric structural locating component (not illustrated in FIG. 1) locates the metallic bipolar plate 17 against the polymeric cell frame 11.

In an alternate example, the inter-electrode separator forms part of the polymeric cell frame, or is integrally formed as part of the polymeric cell frame, and is a polymeric inter-electrode separator, yet is still positioned between the first electrode and the second electrode.

The example in FIG. 1 depicts the case where both of compressive components 15 and 16 (e.g. metallic porous transport layer compressive components 15 and 16) have a compressive function. However, it is to be understood that an alternative preferred example involves one of the compressive components 15 and 16 (e.g. one of the porous transport layers 15 and 16), for example the first compressive component 15, having a compressive function (i.e. being a metallic porous transport layer compressive component) and the other, for example the second porous transport layer 16, having a compliant function (i.e. being a metallic porous transport layer compliant component).

The image at the bottom right of FIG. 1 depicts the fully assembled cell 10.

As can be seen in FIG. 1, the following important points pertain to cell 10:
(1) The polymer-to-metal joins between the metallic bipolar plates 17 and 18 and the uncovered, exposed polymer surfaces on the opposite sides of cell frame 11, lead to the compressive components 15 and 16 (e.g. springed porous transport layers 15 and 16) being compressed against the electrodes 13 and 14 respectively. That is, the architecture of the cell 10 causes cell 10 to be internally compressed. This compression is generally more easily, quickly, reliably, uniformly, and precisely achieved, in a more controllable and forgiving way, in the assembly of individual cells than it is when many cells need to be simultaneously compressed during the assembly of a large cell stack. Moreover, in already being internally compressed, the individual cells can be assembled into or within a cell stack without the need for a particular or high overall compression that must be precisely applied, facially and laterally, as is normally required for assembly of, especially, filter-press type cell stacks. Furthermore, each individual cell can be separately tested to determine whether its internal compression and operation is correct prior to forming the cell stack. This option is not available when the needed cell assembly and compression (clamping force) is created only during the formation of the cell stack, as is normally required in, especially, filter-press type cell stacks. Additionally, individual cells that malfunction, or in which the needed compression is lost during operation, can be easily removed and replaced in the cell stack. This option is also not conventionally available; the entire conventional cell stack must be disassembled and then re-assembled—an arduous and time-consuming task.
(2) The polymer-to-metal joins between the metallic bipolar plates 17 and 18 and the uncovered, exposed polymer surfaces on the opposite sides of cell frame 11, lead to the ‘cell body’ of the individual cells being fully sealed. That is, the ‘cell body’ of each cell is sealed internally, by its components. That is, the internal region of the cell is sealed, or in other words the cell is sealed. This diminishes the need to create reliable seals by accurate and precise, facial and lateral, compression as is normally required during the assembly of a filter-press-type cell stack. Moreover, each individual cell can be separately tested to determine whether its cell body is properly sealed prior to assembling the cell stack. This option is not available when the needed sealing of the cell body is created only during formation of the cell stack. Additionally, cells in which the sealing of the cell body fails during operation can be easily removed and replaced in the cell stack. This option is not available in conventional cell stacks; the entire conventional cell stack must be disassembled and then re-assembled—an arduous and time-consuming task.
(3) The polymer-to-metal joins between the metallic bipolar plates 17 and 18 and the uncovered, exposed polymer surfaces on the opposite sides of cell frame 11, lead to the components of the individual cell being positioned in their optimum locations about the cell frame and within the cell. That is, the compressive components 15 and 16 (e.g. springed porous transport layers 15 and 16) and the electrodes 13 and 14 are held in compressive tension in their correct locations within the cell. This diminishes the need to accurately position the cell components during the formation of the cell stack. Moreover, each individual cell can be separately tested to determine whether its components are correctly positioned prior to forming the cell stack. This option is not available when the needed positioning of the cell components is created only during the formation of the cell stack. Additionally, cells in which the components move and become incorrectly positioned during operation can be easily removed and replaced in the cell stack. This option is not available in a conventional cell stack; the entire conventional cell stack must be disassembled and then re-assembled—an arduous and time-consuming task.

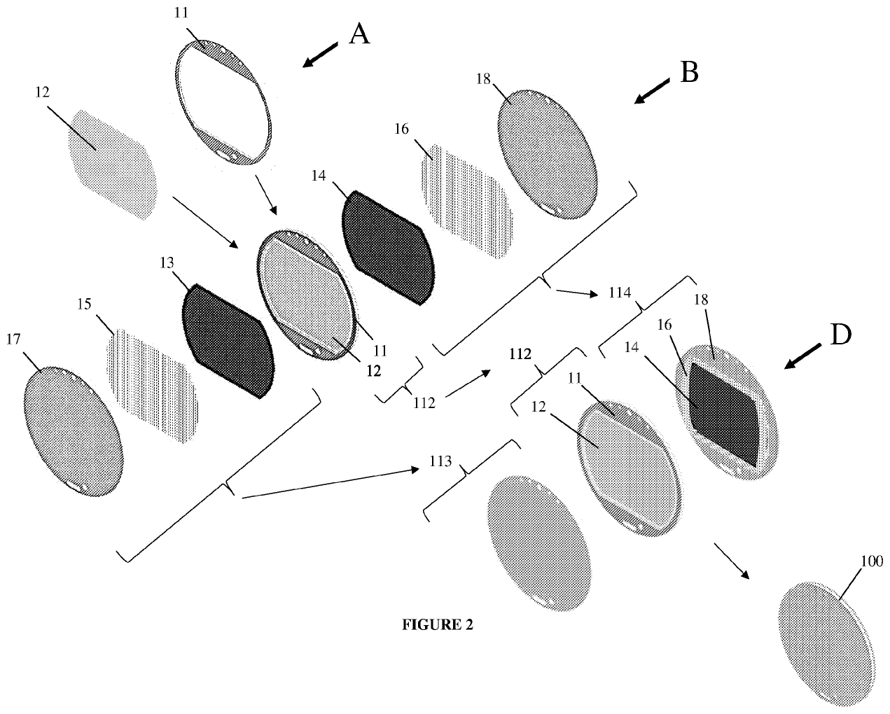

FIG. 2 schematically depicts another preferred example embodiment electro-energy or electro-synthetic cell 100. As can be seen, the components involved in rows A and B are the same as in FIG. 1. However, in this example embodiment, metal-to-metal joins, for example metal-to-metal welds, have been used to attach the second metallic bipolar plate 18 to the second compressive component 16 (e.g. the second metallic porous transport layer compressive component 16) and to the second metallic electrode 14, forming the second metal-to-metal joined assembly 114.

Similarly, metal-to-metal joins, for example metal-to-metal welds, have been used to attach the first metallic bipolar plate 17 to the first compressive component 15 (e.g. the first metallic porous transport layer compressive component 15) and to the first metallic electrode 13, forming the first metal-to-metal joined assembly 113.

Row D in FIG. 2 depicts the polymeric assembly 112 (which comprises the polymeric cell frame 11 and the polymeric inter-electrode separator 12 attached and sealed to each other via polymer-to-polymer joins), flanked by the second metal-to-metal joined assembly 114 (comprising the metal-to-metal joined, for example metal-to-metal welded, functional components of one of the half-cells), and the first metal-to-metal joined assembly 113 (comprising the metal-to-metal joined, for example metal-to-metal welded, components of the other half cell).

Cell 100 is formed when the first metallic bipolar plate 17 (part of first metal-to-metal joined assembly 113) and the second metallic bipolar plate 18 (part of second metal-to-metal joined assembly 114) are securely attached by polymer-to-metal joins to the uncovered, exposed polymer surfaces at the top, bottom and around the sides of the cell frame 11, on both sides, that is on the front and the back of the cell frame 11 respectively.

The polymer-to-metal joins between the metallic bipolar plates 17 and 18, and the polymeric cell frame 11 seal the ‘cell body’ of cell 100.

The polymer-to-metal joins between the metallic bipolar plates 17 and 18, and the polymeric cell frame 11 also lead to the compressive components 15 and 16 (e.g. springed porous transport layers 15 and 16), which are part of the metal-to-metal joined assemblies 113 and 114 respectively, internally exerting a clamping force on the electrodes 13 and 14 respectively, compressing the electrodes 13 and 14 tightly against opposite sides of the inter-electrode separator 12. Electrodes 13 and 14 are part of the metal-to-metal joined, for example metal-to-metal welded, assemblies 113 and 114, respectively.

The example in FIG. 2 depicts the case where both of the compressive components 15 and 16 (e.g. porous transport layer compressive components 15 and 16) have a compressive function. However, it is to be understood that, an alternative preferred example involves one of the compressive components 15 and 16 (e.g. one of the porous transport layers 15 and 16) having a compressive function, e.g. first compressive component 15 (i.e. being a metallic porous transport layer compressive component), and the other, e.g. porous transport layer 16, having a compliant function (i.e. being a metallic porous transport layer compliant component).

The image at the bottom right of FIG. 2 depicts the cell 100, thus assembled. As can be seen in FIG. 2, all of the important points (1) to (3) described above in the discussion around FIG. 1, also pertain to cell 100 in FIG. 2.

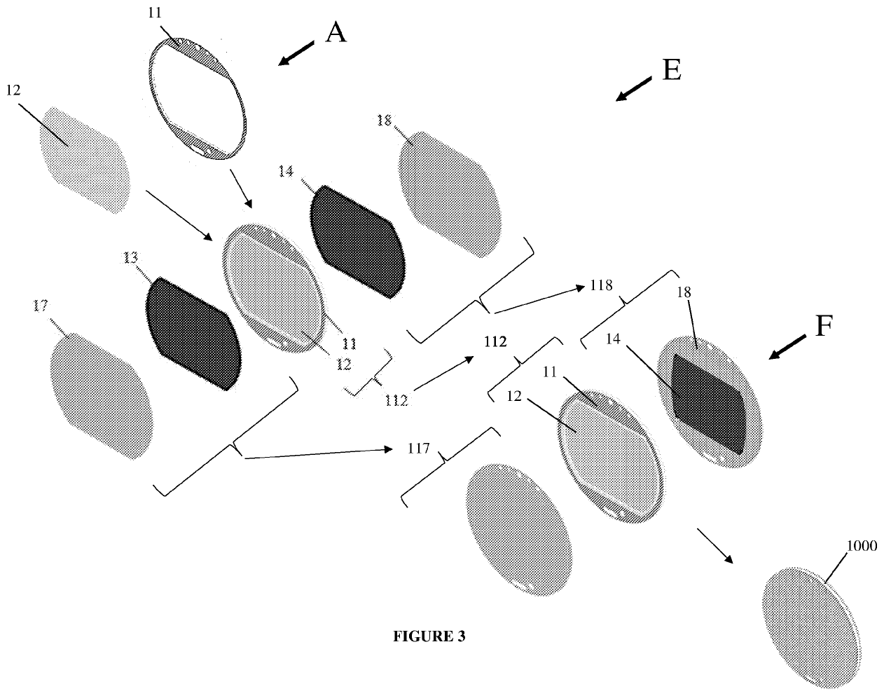

FIG. 3 schematically depicts a most preferred example embodiment of an electro-energy or electro-synthetic cell 1000. As can be seen, the components involved in row A are the same as in FIG. 1 and FIG. 2. However, in this example embodiment, there are no components 15 and 16 (e.g. no porous transport layer compressive components 15 and 16). Instead, the bipolar plates 17 and 18 are compressive components. The bipolar plates are also capable of acting as porous transport layers; that is, they have on their surfaces facing their electrodes 13 and 14 respectively, porous structures that allow gases or liquid to access their electrodes, 13 and 14 respectively. The nature and character of such porous structures is discussed in a following section below.

That is, as shown in row E of FIG. 3, the metallic functional components of one half cell comprise the second compressive, metallic bipolar plate 18 (i.e. second metallic bipolar plate compressive component 18) and the second metallic electrode 14, while the metallic functional components of the other half cell comprise the first compressive, metallic bipolar plate 17 (i.e. first metallic bipolar plate compressive component 17) and the first metallic electrode 13.

In the example illustrated in FIG. 3 there is shown an electro-energy or electro-synthetic cell 1000 comprising a polymeric cell frame 11, first electrode 13 and second electrode 14. The inter-electrode separator 12 is sealed to the cell frame 11 and positioned between first electrode 13 and second electrode 14. A metallic bipolar plate compressive component 17 is positioned adjacent to, next to or abutting first electrode 13.

Preferably, the polymeric cell frame 11 is sealed to the metallic bipolar plate compressive component 17. In one example, a seal between the polymeric cell frame 11 and the metallic bipolar plate compressive component 17 is created by a polymer-to-metal join. In another example (that is discussed in detail in the Second Preferred Example Embodiment Cell Architecture section below), at least one polymeric structural locating component (not illustrated in FIG. 3) locates the metallic bipolar plate compressive component 17 against the polymeric cell frame 11. In this example, a seal between the polymeric cell frame 11 and the metallic bipolar plate compressive component 17 can be created by one or more polymer-to-polymer joins between the at least one polymeric structural locating component and the polymeric cell frame 11 and the at least one polymeric structural locating component mechanically holding the metallic bipolar plate compressive component 17 against the polymeric cell frame 11.

A second metallic bipolar plate compressive component 18 is positioned adjacent to, next to or abutting second electrode 14. Preferably, the polymeric cell frame 11 is sealed to the second metallic bipolar plate compressive component 18. In one example, a seal between the polymeric cell frame 11 and the second metallic bipolar plate compressive component 18 is created by a polymer-to-metal join. In another example (that is discussed in detail in the Second Preferred Example Embodiment Cell Architecture section below), at least one further polymeric structural locating component (not illustrated in FIG. 3) locates the second metallic bipolar plate compressive component 18 against the polymeric cell frame 11. In this example, a seal between the polymeric cell frame 11 and the second metallic bipolar plate compressive component 18 can be created by one or more further polymer-to-polymer joins between the at least one polymeric structural locating component and the polymeric cell frame 11 and the at least one polymeric structural locating component mechanically holding the second metallic bipolar plate compressive component 18 against the polymeric cell frame 11.

The first electrode 13 and the second electrode 14 are positioned in the polymeric cell frame 11. For example, as illustrated, the polymeric cell frame 11 includes a window cut-out, and the first electrode 13 and the second electrode 14 are positioned in the window cut-out of the polymeric cell frame 11. The inter-electrode separator 12 is also positioned in the polymeric cell frame 11, between the first electrode 13 and the second electrode 14. Preferably, the inter-electrode separator 12 is a polymeric inter-electrode separator, and the polymeric cell frame 11 is joined to the polymeric inter-electrode separator via a polymer-to-polymer join. Preferably, the first electrode 13 is a first metallic electrode and the second electrode 14 is a second metallic electrode.

Moreover, metal-to-metal joins, for example metal-to-metal welds, may be used to attach the second metallic bipolar plate compressive component 18 to the second metallic electrode 14, forming the second metal-to-metal joined assembly 118. Similarly, metal-to-metal joins, for example metal-to-metal welds, may be used to attach the first metallic bipolar plate compressive component 17 to the first metallic electrode 13, forming the first metal-to-metal joined assembly 117.

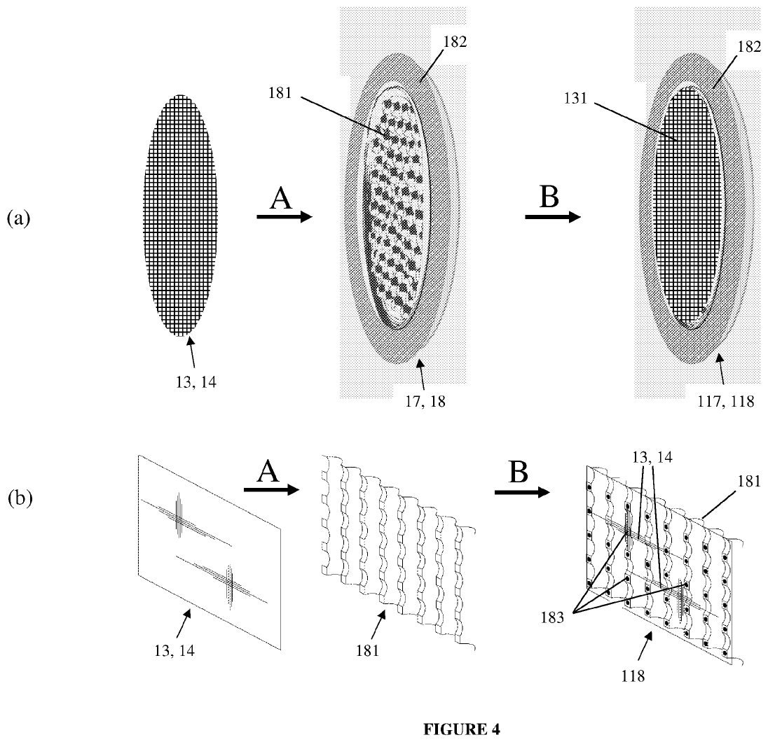

FIG. 4(a) depicts an example embodiment metallic bipolar plate compressive component 17 or 18 (i.e. metallic waffle bipolar plate), which may be suitable for such direct attachment to a metallic electrode, and the attachment of a metallic electrode 13 or 14 to it via metal-to-metal joins, for example metal-to-metal welds.

Metallic bipolar plate compressive component 17 or 18 has a flow field with a ‘waffle’ structure 181 (or grid or grate arrangement of pits and lands, or ribs and spaces, or steps and voids) upon a portion of its face. A ‘waffle’ structure resembles in some measure, the structure present on a waffle iron. The metallic bipolar plate compressive component 17 or 18 depicted in FIG. 4(a) is a metal sheet whose face has been etched, machined, stamped, formed, sunk, or otherwise fashioned into a waffle structure 181, i.e. a grid structure or a grate. The metallic bipolar plate compressive component 17 or 18 also has a flat peripheral region 182 around the waffle structure 181 that has no flow field impressed it. The waffle portion of the metallic bipolar plate 17 or 18 may have a somewhat domed shape, testifying to the fact that it is springed or sprung.

In step A of FIG. 4(a), a metallic electrode 13 or 14, being a metallic mesh electrode, is placed over the waffle structure 181. The metallic mesh electrode is thereafter, in step B, directly attached to at least some or all of the lands of the waffle structure 181 by metal-to-metal joins, for example metal-to-metal welds that attach the metallic electrode 13 or 14, i.e. the metallic mesh electrode, to some or all of the ribs or the steps of the grid structure or grate on the face of the metallic bipolar plate compressive component 17 or 18. The resulting metal-to-metal joined assembly 117 or 118 comprises the metallic electrode 13 or 14 respectively, attached by metal-to-metal joins to some or all of the lands of the waffle structure 181, with the flat peripheral region 182 of the metallic bipolar plate compressive component around the waffle structure 181 untouched.

FIG. 4(b) depicts a close up view of how such metal-to-metal joins may be achieved. The metallic electrode 13 or 14, in this case a metallic mesh electrode, may be placed over the waffle structure 181. Metal-to-metal joins, for example metal-to-metal welds, may then be created at some or all of the points 183, where the strands of the mesh 13 or 14 overlay the lands of the waffle structure 181.

Metal-to-metal joins of this type, for example metal-to-metal welds, may stabilize the structure of the bipolar plate, halting, slowing, or avoiding distortions, such as ‘springback’. In so doing, the metal-to-metal joins may minimize variations in the physical dimensions of the bipolar plate and its flow field, thereby allowing for the use of precision industrial stamping, forming, and other high-speed, high-volume manufacturing processes.

The metal-to-metal joins between the metallic bipolar plate compressive component (i.e. the metallic waffle bipolar plate 181) and the metallic electrode 13 or 14 may further provide for high electrical conductivity between these components and a uniform distribution of electrical current and voltage at the attached electrode. The number of metal-to-metal joins may be selected to be the optimum number taking into account the desired electrical conductivity between these components and the desired areal distribution of electrical current and voltage at the attached electrode

The metal-to-metal joins between the metallic bipolar plate compressive component (i.e. the metallic waffle bipolar plate 181) and the metallic electrode 13 or 14 may also provide for high thermal conductivity between these components and a uniform distribution of the heat produced by the cell. For example, the heat produced at the electrodes may be efficiently conducted to the metallic bipolar plate compressive component 17 or 18, which may be cooled to thereby maintain the temperature of the cell.

Returning to FIG. 3, row F in FIG. 3 depicts the polymeric assembly 112 (which comprises the polymeric cell frame 11 and the polymeric inter-electrode separator 12 attached and sealed to each other via polymer-to-polymer joins), flanked by the metallic assembly 118 (comprising the metal-to-metal joined metallic bipolar plate compressive component 18 and second electrode 14; i.e. the metallic functional components of one of the half-cells), and the metallic assembly 117 (comprising the metal-to-metal joined metallic bipolar plate compressive component 17 and the first electrode 13; i.e. the metallic functional components of the other half cell).

Cell 1000 is formed when the metallic bipolar plate compressive component 17 (part of metal-to-metal joined assembly 117) and metallic bipolar plate compressive component 18 (part of metal-to-metal joined assembly 118) are attached by polymer-to-metal joins to the uncovered, exposed polymer surfaces at the top, bottom and around the sides of the polymeric cell frame 11, on its front and the back respectively.

This may involve a peripheral area (e.g. flat peripheral region 182 in FIG. 4) of a metallic waffle bipolar plate 17 or 18 being attached to the polymeric cell frame 11 via one or more polymer-to-metal joins. The image at the bottom right of FIG. 3 depicts the cell 1000, thus assembled. The somewhat domed shape of the waffle structure 181, may thereby be flattened out, meaning that its springed (or sprung) nature has been harnessed to exert an internal clamping force on the attached electrode 13 or 14 within the cell 1000, compressing it against the inter-electrode separator 12. That is, once assembled by forming the polymer-to-metal join between 117 or 118 and the cell frame 11, the springed waffle structure within 117 or 118, provides a compressive component that clamps the attached electrode 13 or 14 respectively, tight against the inter-electrode separator 12.

The polymer-to-metal joins between the metallic bipolar plate compressive components 17 and 18 and the polymeric cell frame 11 may further seal the ‘cell body’ of the electro-synthetic or electro-energy cell 1000. The example in FIG. 3 depicts the case where both of the metallic bipolar plate compressive components 17 and 18 have a compressive function. However, it is to be understood that an alternative preferred example involves one of the metallic bipolar plate compressive component 17 or 18 having a compressive function and the other having a compliant function. For example, there may be provided a metallic bipolar plate compressive component and a metallic bipolar plate compliant component.

It is to be understood that the purpose of such a waffle bipolar plate in this example embodiment is to include and combine the function of a porous transport layer within a bipolar plate. Thus, the waffle structure contains voids between the lands of the waffle; these voids provide for porosity of the same type found in a porous transport layer. Accordingly, any bipolar plate flow field that provides such voided porosity may potentially be used without need for a separate porous transport component. That is, the waffle structure depicted provides only one example of a bipolar plate that may also function as a porous transport layer. Any such voided, porous bipolar plates may fall within the scope of the term ‘waffle bipolar plate’ or ‘metallic waffle bipolar plate’.

It is further to be understood that, whereas only FIGS. 3 and 4 and associated text explicitly discuss the use of a metallic waffle bipolar plate, the example embodiments described using FIG. 1 and FIG. 2 and their associated text may also make use of one or more metallic waffle-type bipolar plates.

As can be seen in FIG. 3, all of the important points (1) to (3) described above in the text associated with FIG. 1, also pertain to cell 1000 in FIG. 3. A feature of the example cells 10, 100, and 1000 is the complete absence of gaskets in their cell architecture.

Additionally: metal-to-metal joins such as, for example, metal-to-metal welds, may provide for reduced or unchanging electrical resistance between metallic functional materials, thereby providing for improved energy efficiency by an electro-energy or electro-synthetic cell during operation. Preferred embodiments may employ such metal-to-metal joined structures because the compression involved in cell assembly may be too low to damage or destroy the metal-to-metal joins, for example metal-to-metal welds. Moreover, when the assembled cells are then combined into cell stacks, low compression may, again, be required. By contrast, as noted in the Background section, in conventional cell stack formation, very much higher compression is typically required; such high compression may readily damage or destroy any metal-to-metal joins present, for example, metal-to-metal welds.

Preferably, the polymeric inter-electrode separator in the above example embodiments is thin, to thereby maximise the energy efficiency of the cell. Preferably, the polymeric inter-electrode separator is less than 0.35 mm thick, less than 0.2 mm thick, less than 0.1 mm thick, less than 0.05 mm thick, or less than 0.025 mm thick.

### Preferred Example Embodiment Cell Stack Assembly

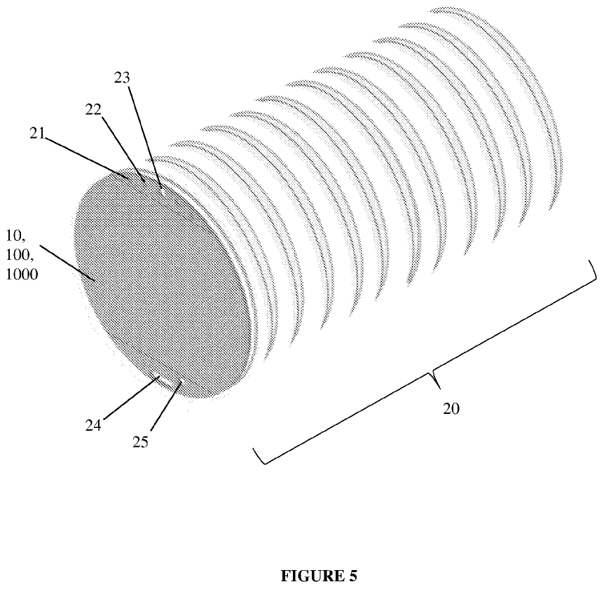

FIG. 5 schematically depicts how example cells 10, 100, or 1000 may be stacked in a cell stack 20. The apertures/openings at the top of each cell 10, 100, 1000 (e.g. 21-23 in FIG. 5) and at the bottom of each cell 10, 100, 1000 (e.g. 24-25) are known as headers or manifold apertures. The header/manifold apertures/openings in each cell within the stack line up after assembly of the stack, to thereby form, effectively, pipes through the length of the cell stack 20.

Normally, in a conventional filter-press type cell stack, headers like that formed by apertures/openings 21, 22, 23, 24, 25 would be sealed to each other by tightly compressing the cells in the stack between two endplates during stack assembly and maintaining such compression thereafter. A particular, high compression would typically be needed to ensure that liquids and/or gases in the headers were not able to leak from the formed pipes, or mix by flowing into the spaces between the cells. The metallic bipolar plates between the cells in such a filter-press-type cell stack would similarly be sealed to their cell frames by compression rather than by polymer-to-metal joins, as described above. The needed compression of the components in each cell, including the clamping of the electrodes against the inter-electrode separator, would normally also be provided by the compression applied to the cell stack during its formation and thereafter.

In preferred example embodiments however, it is not necessary to seal the bipolar plates by compression of the cell stack as the bipolar plates are already attached to their cell frame by polymer-to-metal joins during assembly of the cell. It may also not be necessary to provide the needed clamping force compressing the electrodes against the inter-electrode separator in each cell, since such clamping forces already exist as a consequence of (pre-) assembling the cell. The need to compress the cell stack accurately and precisely, facially, and laterally, during its formation and thereafter, may thereby be diminished.

Accordingly, preferred embodiment cell stacks are, preferably, formed (and fully sealed) by moderately compressing the cells together and then sealing the header/manifold apertures or openings in each cell to the equivalent header/manifold apertures or openings in the next cell in the stack until all of the header/manifold apertures or openings in the stack are sealed. All of the header/manifold apertures or openings in the stack may also be simultaneously sealed, i.e. they may be sealed all at once.

The header/manifold apertures or openings of electro-synthetic or electro-energy cell may be sealed to the equivalent header/manifold apertures or openings of the next cell in the stack, during cell stack assembly, via one or more polymer-to-polymer joins. That is, an assembled cell, whose ‘cell body’ is already sealed due to its cell architecture, may be completely sealed during cell stack assembly by creating the liquid and/or the gas connections into and out of the remainder of the cell stack by polymer-to-polymer joins. Such polymer-to-polymer joins may further diminish the need to create seals by accurate and precise compression during the assembly of the cell stack and thereafter.

Any polymer-to-polymer joining technique may be used to create the needed joins, including any of the polymer-to-polymer joining techniques described or listed in this specification.

In a particularly preferred example, such polymer-to-polymer joins may be created by patterning and placing a resistive metal wire or electrical circuit around the polymeric header/manifold apertures to be sealed on each cell. After the cells are stacked for cell assembly and compressed to the extent required, an electrical current may be passed through each of the circuits present, causing heating of each circuit, resulting in melting, and fusion of the polymeric materials of the adjacent cells about the circuit. The resulting cell stack architecture may comprise cells stacked and joined together via polymer-to-polymer joins that incorporate resistive wires and/or electrical circuits about the header/manifold apertures.

In another preferred example, a gasket, such as a shaped sheet or ring of rubber may be placed around a first portion of the polymeric regions to be sealed, followed by polymer-to-polymer sealing of the type described above in a second portion of the polymeric regions to be sealed. The gasket may provide an additional, long-term defence against leaking that may be especially useful where structurally complex polymer-to-polymer joining is needed. The resulting cell stack architecture may comprise cells stacked and joined together via polymer-to-polymer joins that incorporate resistive wires and/or electrical circuits, with gaskets near to the polymer-to-polymer join, about the header/manifold apertures.

In other examples, the polymer-to-polymer welding required may be too complex or demanding to seal reliably, in which case one or more gaskets may be used. The resulting cell stack architecture may comprise cells stacked, with one or more gaskets about the header/manifold apertures, wherein compression of the stack maintains the gasket seals.

The sealing architectures described above may provide for simplified and reliable assembly of components and cells into or within cell stacks that do not leak or mix the liquid or gas reactants and products, both after assembly and during subsequent operation. They may also provide for high-speed, high-volume, industrial assembly of electro-synthetic or electro-energy cell stacks.

In an example, the cell stack is a filter-press type cell stack. In another example, a liquid inlet header of the cells within the cell stack is pressurised to a higher pressure than the liquid in each cell, and a liquid outlet header of the cells within the cell stack is pressurised to a lower pressure than the liquid in each cell. In preferred examples, the overall compression pressure applied to the cell stack during assembly and thereafter, such as during electrochemical operation, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, greater than 20 bar, greater than 30 bar, greater than 40 bar, greater than 50 bar, or greater than 100 bar.

The compression may be maintained by torsional, mechanical, hydraulic (i.e. liquid), or other means that can accommodate dimensional changes in the length of the cell stack as may occur during repeated temperature or pressure cycling.

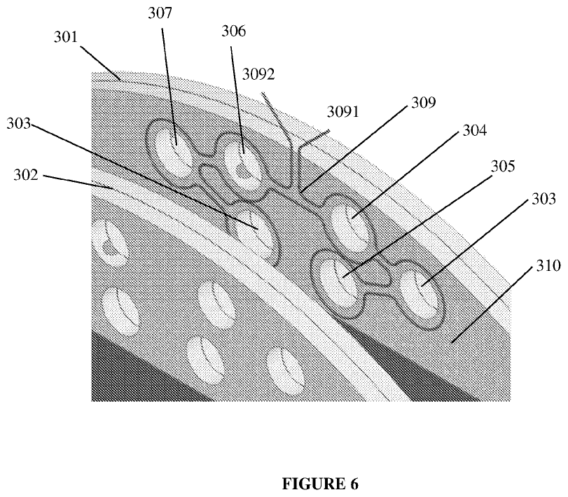

FIG. 6 schematically illustrates the sealing of header/manifold apertures by patterning and placing a resistive metal wire or electrical circuit around the polymeric header/manifold apertures to be sealed on each cell.

FIG. 6 depicts a cell 301 with multiple header apertures 303-308. A second cell 302 with equivalent header apertures is placed up against cell 301, with its header apertures in register with the header apertures 303-308 in cell 301. To seal the header apertures 303-308 on cell 301 to their equivalent header apertures on cell 302, a wire 309, preferably a thin wire, may be bent in a pattern matching the headers, whereafter wire 309 is placed around the headers 303-308 on the surface 310 of the cell 301. The cell frames 301 and 302 are then compressed together and a current is passed along the wire 309 by connecting a suitable electricity source across its two ends 3091 and 3092. The wire 309 heats up due to the current passing through it, melting the polymer adjacent to it in cells 301 and 302, and causing the polymeric cell frames of cells 301 and 302 to fuse together around the wire 309, sealing the headers 303-308 in cell 301 to their equivalent headers in cell 302. This process may be repeated with many cell frames, creating a sealed cell frame stack. In an example, a liquid inlet header of the cells within the cell stack can be pressurised to a higher pressure than the liquid in each cell, and a liquid outlet header of the cells within the cell stack can be pressurised to a lower pressure than the liquid in each cell.

In this way it may be possible to assemble electro-energy or electro-synthetic cell stacks with moderate to little compression during assembly and subsequent operation. The need to maintain the cell stack under a precise lateral and facial compression for its lifetime of operation after assembly of the stack, may also be diminished, or even eliminated entirely.

Patterned wires of this type may also be placed around the periphery of the cell frame, allowing multiple cell frames to be welded together in the same way. Patterned wire may further be placed around other header and/or other features to seal them in the same way.

It is to be understood that numerous alternatives exist for the wire 309. For example, instead of a wire, a thin polymer film coated with a layer of conductive metal and cut into the shape shown for 309 may be used. Such a polymer cut-out may be placed as depicted for 309 in FIG. 6. Inclusion of the thin, cut-out polymer film (coated with a thin layer of conductive metal and shaped as shown for 309) between the polymeric cell frames of cells 301 and 302 when they are compressed together, may produce a better seal than a wire (when electrically heated to create the seal).

‘Inter-cell’ polymer-to-polymer joins of the type described above may further diminish the challenge of creating seals by accurate and precise compression during cell stack formation. They may also provide for more reliable seals that are less reliant on the maintenance of invariant, high compression across the cell stack. By contrast, conventional cell stacks rely, essentially entirely, on high compression, maintained invariantly, to create and maintain such ‘inter-cell’ seals.

### Example Preferred Embodiments: A Second Preferred Example Embodiment Cell Architecture: Use of a ‘Structural Locating Component’

In other example embodiments, the dimensions of the polymeric components (e.g. cell frame 11 and inter-electrode separator 12) may change more than the dimensions of the metallic components (e.g. bipolar plates 17 and 18, porous transport layers 15 and 16, and electrodes 13 and 14) during thermal or pressure cycling of the type that may occur during operation. This may be due the different coefficient of thermal expansion or pressure-induced expansion of the polymeric components relative to the metallic components.

In such a case, it may not be possible to achieve a reliable seal by physically attaching a metallic component (e.g. a bipolar plate 17 or 18) to a polymeric component (e.g. a cell frame 11) via one or more a polymer-to-metal joins. Instead, it may be necessary to structurally constrain a physically disconnected metallic component/s close to or tight against the polymeric component to thereby seal their junction. Alternatively, a suitably shaped gasket may be positioned between the metallic component and the polymeric component to seal their junction more securely. The creation of a close structural match of the metallic component and the polymeric component may ensure the operating stresses applied to the gasket during operation of the cell may be minimized.

In a, non-limiting, second preferred example embodiment, there is provided electro-energy or electro-synthetic cell architectures comprising at least one polymeric cell frame, to which is attached:
at least one polymeric inter-electrode separator, by or via one or more polymer-to-polymer joins; and
at least one polymeric ‘structural locating component’, by or via one or more polymer-to-polymer joins, wherein the at least one polymeric structural locating component mechanically holds at least one metallic functional component in a suitable position within or about the cell frame.

Preferably, the polymeric inter-electrode separator in the above example embodiments is thin, to thereby maximise the energy efficiency of the cell. Preferably, the polymeric inter-electrode separator is less than 0.35 mm thick, less than 0.2 mm thick, less than 0.1 mm thick, less than 0.05 mm thick, or less than 0.025 mm thick.

The at least one metallic functional component may comprise a metallic bipolar plate, for example a metallic bipolar plate compressive component. The metallic bipolar plate may form part of a metal-to-metal joined assembly that contains at least one metallic bipolar plate and at least one metallic electrode, as well as, optionally, at least one metallic porous transport layer. The at least one polymeric structural locating component may mechanically hold the metal-to-metal joined assembly in a suitable position within or about the cell frame. The metallic bipolar plate of the at least one metal-to-metal joined assembly may be held tight up against the polymeric cell frame, thereby sealing their junction. Alternatively, a suitable gasket may be present between the bipolar plate and the cell frame to thereby provide for an enhanced seal.

The at least one metallic functional component may, alternatively, comprise a metallic electrode or a metallic porous transport layer. The metallic electrode or the metallic porous transport layer may form part of a metal-to-metal joined assembly containing at least one metallic bipolar plate, in a suitable position within or about the cell frame. The at least one polymeric structural locating component may mechanically hold the at least one metal-to-metal joined assembly in a suitable position within or about the cell frame.

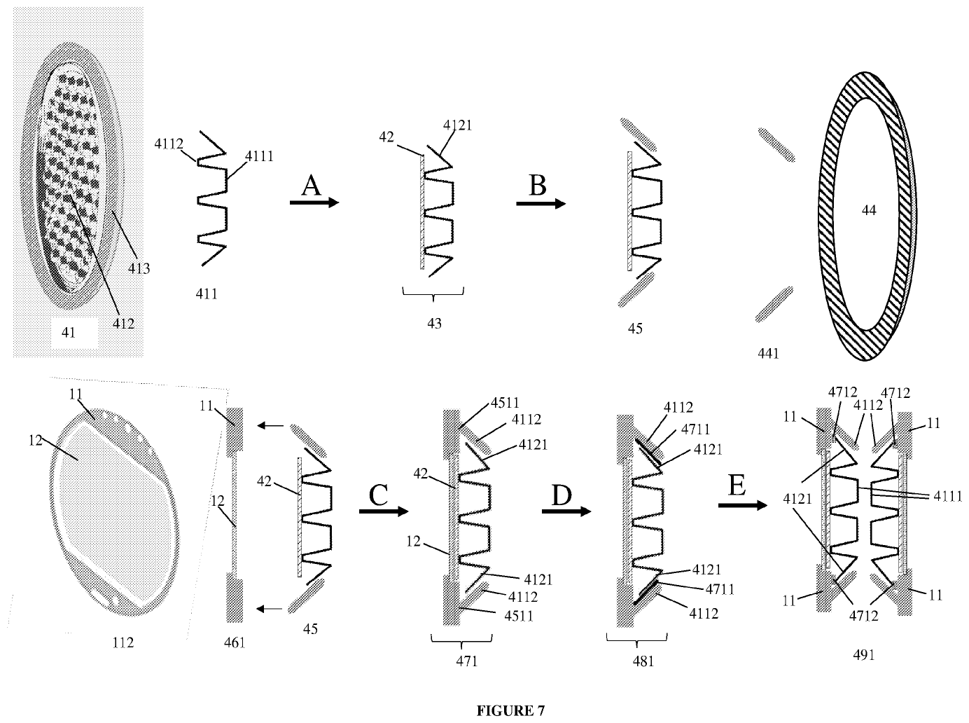

FIG. 7 schematically depicts an example of a single half-cell of a preferred embodiment.

The top left of FIG. 7 depicts a metallic waffle bipolar plate 41 (i.e. a metallic bipolar plate compressive component) comprising a waffle structured area 412 and a surrounding, peripheral area 413 that is flat and has no flow field upon it. Structure 411 is a schematic depiction of a cross-section of the waffle bipolar plate 41, showing the pits (e.g. pits 4111) and lands (e.g. lands 4112). The waffle bipolar plate may, for example, have been fabricated by an industrial precision stamping or forming process.

In step A in FIG. 7, a metallic electrode 42, preferably a flat metallic mesh electrode, is attached to at least some or all of the lands of 411 by one or more metal-to-metal joins, for example metal-to-metal welds. This may involve, for example, welding the metallic electrode 42 to the bipolar plate 411 at some or all of the lands (e.g. 4112). The resulting electrode-bipolar plate assembly 43, depicted as a cross-section, is then a single metallic part held together by the metal-to-metal joins, for example metal-to-metal welds. The peripheral area 413 (a flat peripheral region with no flow field upon it) of bipolar plate 41, is separate from the waffle portion with attached metallic electrode 42, and is marked as section 4121 in electrode-bipolar plate assembly 43.

The top right of FIG. 7 schematically depicts a polymeric ‘structural locating component’ 44, which has the form of a polymeric cover disk having a flattened doughnut-shape that is shown schematically in cross section as cross-section 441. The central opening of the polymeric ‘structural locating component’ 44 is sized to partially enclose bipolar plate 41 and attached metallic electrode 42 (i.e. electrode-bipolar plate assembly 43). Cross-section 45, after step B in FIG. 4, shows in schematic cross-section, how electrode-bipolar plate assembly 43 fits into and is covered by the polymeric ‘structural locating component’ cross-section 441.

The bottom left of FIG. 7 shows a cell frame 11 incorporating an attached inter-electrode separator 12, fabricated as described for assembly 112 in FIGS. 1, 2, and 3.

The resulting assembly 112 is depicted in schematic cross-section as cross-section 461.

Step C in FIG. 7 depicts a cross-section of the polymeric ‘structural locating component’ cross-section 441 with electrode-bipolar plate assembly 43 inside it (i.e. assembly 45) being attached to cell frame 11 (i.e. in assembly 112) by polymer-to-polymer joining. The polymer-to-polymer joins in the resulting assembly 471 are shown at locations 4511.

As can be seen in the schematic cross-section of assembly 471, the peripheral area 413 (a flat peripheral area with no flow field upon it) of metallic bipolar plate 41 (i.e. section 4121) may thereby be mechanically held close to or tight against the inner surface 4112 of the polymeric ‘structural locating component’ 44. In so doing, the junction between the metallic bipolar plate 4121 and the section 4112 of polymeric ‘structural locating component’ 44 may be sealed. The electrode-bipolar plate assembly 43 may, nevertheless, be physically disconnected from the polymer structures in assembly 471.

The somewhat bowed shape of the compressive waffle bipolar plate 41 may now be flattened, indicating that its springed (or sprung) nature has been harnessed in assembly 471, to exert a clamping force that compresses the attached electrode 42 against the inter-electrode separator 12.

The polymer-to-polymer joins at locations 4511 in assembly 471 may be created by polymer components with very similar expansion coefficients. Accordingly, the polymer-to-polymer joins at locations 4511 in assembly 471 are unlikely to be pulled apart during thermal or pressure cycling. Moreover, the metallic components 43, which may have very different expansion coefficients, are not physically connected to the polymeric components. Thus, there is no polymer-to-metal join that may be pulled apart during thermal or pressure cycling due to a mismatch of polymer and metal expansion coefficients. This arrangement may therefore accommodate the mismatch in the coefficients of expansion of the polymeric and metallic components during thermal and pressure cycling. That is, the expansion of the metallic assembly 431 need not be matched to the expansion of the polymeric structures since the metallic components are physically disconnected from the polymeric components.

As shown in assembly 481 after arrow D in FIG. 7, a gasket 4711, whose shape matches the outer perimeter of the bipolar plate 41, may be, additionally, introduced into the junction of the metallic bipolar plate 41 (i.e. section 4121) and the polymeric ‘structural locating component’ 44 (i.e. section 4112). That is, the gasket 4711 is positioned at the junction between the metallic bipolar plate and the polymeric cell frame. Such a gasket 4711 may provide an enhanced seal. Because of the close structural match of the metallic bipolar plate (i.e. section 4121) and the polymeric ‘structural locating component’ 44 (i.e. section 4112), the operating stresses applied to the gasket during operation of the cell may be minimized.

Alternatively, as depicted in assembly 491 after arrow E in FIG. 7, a gasket 4712 may be interposed in the junction between the metallic bipolar plate 41 (i.e. section 4121) and the polymeric cell frame 11. Such a gasket 4712 may also provide an enhanced seal. Because of the close structural match of the metallic bipolar plate (i.e. section 4121) and the polymeric cell frame 11, the operating stresses applied to the gasket during operation of the cell may be also minimized.

The location selected for a gasket in this preferred embodiment may be dependent on various factors, including the structural changes in the adjoining polymeric and metallic components during thermal or pressure cycling. A feature of such an example embodiment cell is the use of at least a single gasket 4711 in at least one of its half cells during its assembly and operation.

By these means, it is possible to manufacture a sealed cell that can be tested for quality control purposes prior to assembly into a cell stack 20 as shown in FIG. 5. In such a cell stack 20, the bipolar plates 41 in adjoining cells need to make electrical contact with each other. Cross-sectional assembly 491 in FIG. 7 shows that such contact may be readily made using example embodiment cells. As can be seen, the pits 4111 in the bipolar plate 41 of adjacent cells may make direct contact with each other during even mild compression of the cell stack. Such compression may, additionally, provide improved sealing at the junction of the metallic bipolar plate 41 (i.e. section 4121) with either the polymeric ‘structural locating component’ 44 (i.e. section 4112) and/or the polymeric cell frame 11.

Contacting polymeric ‘structural locating components’ 44 (i.e. section 4112) in adjoining cells may potentially be attached to each other by, for example, polymer-to-polymer joins, either all along the periphery of the ‘structural locating components’, or at selected locations around the periphery. Such polymer-to-polymer welding would, effectively, lock in the compression applied to the cell stack and indefinitely maintain all cells in the stack in their compressed, sealed state. That is, polymer-to-polymer joining of this type may avoid the need to externally maintain the cell stack under compression at all times after it has been assembled, including during electrochemical operation. Moreover, polymer-to-polymer joins of this type may be reliably secure and not subject to pulling apart due to mismatched coefficients of thermal expansion.

Another alternative would be to join some or all of the pits (i.e. pits 4111) of the waffle bipolar plates in the adjacent cells in assembly 491 to each other by metal-to-metal joins, such as may be created by laser welding. Such metal-to-metal joins would also be reliably secure and not subject to pulling apart due to mismatched coefficients of thermal expansion. Moreover, such joins would ensure good electrical contact between cells and down the cell stack. The lateral compression applied to the cell stack would, however, have to be maintained indefinitely and during operation (unless the outer peripheries section 4112 of the polymeric cover disks cross-section 441 on adjacent cells were also affixed to each other).

Optionally, the waffle structure on a bipolar plate 411 in one cell may be structurally complementary to the waffle structure on the bipolar plate 411 of the adjacent cell, allowing the two such waffle structures to interdigitate and mate together when they are compressed together during stack assembly. Such a structural mating may assist in ensuring optimum alignment of the cells in the cell stack. It may also provide for a higher surface area of electrical contact between cells in the cell stack.

To the extent that the seals created by the polymer-to-metal joins described in FIG. 1 and associated text are comparable to the polymer-to-metal seals of the above preferred example embodiment cells, all of the important points (1) to (3) described in the text associated with FIG. 1, also pertain to the above preferred example embodiment cells.

### Tolerance Compensation Features

In various other example aspects, embodiments relate to the polymer-to-polymer, polymer-to-metal, and metal-to-metal joins that may be used in the above cell and cell stack architectures and techniques. Preferably such joins incorporate one or more ‘tolerance compensation features’. ‘Tolerance compensation features’ are features that accommodate low tolerances and high variability in the dimensions of cell components, including in polymeric cell frames that may, for example, be injection moulded. Tolerance compensation features include structures that are designed to accommodate variability in the components being joined. They include channels, grooves, slots, tongues, and other structural features that are slightly over-sized or slightly under-sized or slightly mismatched to another feature, to thereby accommodate variations in the quantity of materials released during joining. Some tolerance compensation features may be incorporated within positive engagement components, such as tongue and groove joints, locating pins and wells, and the like.

Preferably, but not exclusively, the following joins that incorporate tolerance compensation features and that are described below, may be used:
(1) ‘sealed wire welding’ joins
(2) ‘ridged polymer-to-metal’ joins

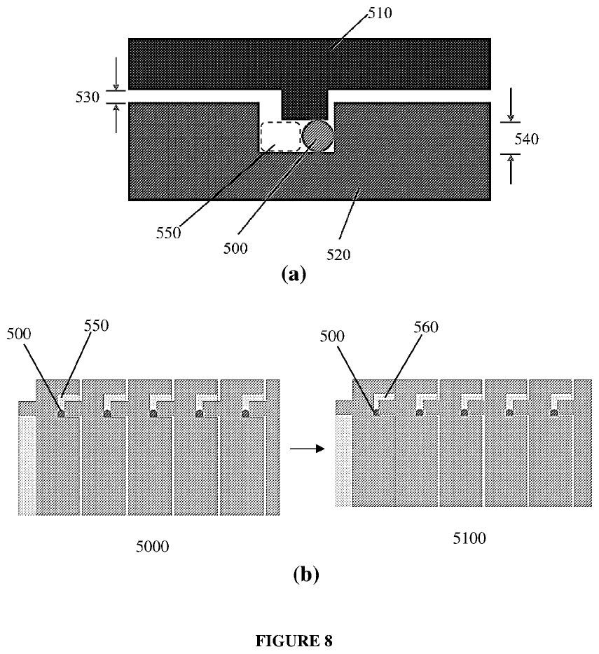

FIG. 6 schematically illustrates the sealing of header/manifold apertures during cell stack assembly by patterning and placing a resistive metal wire or electrical circuit around the polymeric header/manifold apertures to be sealed on each cell. FIG. 8 schematically illustrates a tolerance compensation feature that may be incorporated into such a sealing process. The tolerance compensation feature forms part of a positive engagement component, namely, a tongue-in-groove joint or fitting. The tolerance compensation feature is referred to as ‘sealed wire welding’.

As can be seen in the schematic cross-section shown in FIG. 8(a), the resistive wire 500 is included in a groove 550 in one side 520 of the polymer-to-polymer junction. The groove 550 is slightly oversized relative to the tongue protruding from the other side 510 of the polymer-to-polymer junction. This leaves a larger volume, shown by the dashed line in FIG. 5(a), than would normally be needed to accommodate the tongue from other side 510. That is, the gap 540 between the bottom of the tongue from other side 510 and the bottom of the groove in side 520 is larger than the gap 530 between the one side 520 of the polymer-to-polymer junction and the other side 510.

When the cell stack is assembled, as depicted in FIG. 8(b), the polymer-to-polymer junctions between the different cells are lined up as shown in stack 5000. When the wire in the left-most junction is then heated by passing an electrical current through it, its tongue melts and partially fills its groove, leaving a reduced but not a zero free volume 560. Tongue-in-groove junctions, when engaged, normally leave zero free volume.

Thus, provided that the groove is sized so that there is always some free volume 560 remaining after melting, the slightly oversized groove may compensate for variations in the physical dimensions of the parts. That is, variations in the physical dimensions of the parts (i.e. a low tolerance) may be compensated by changes in the free volume 560 as the polymer-to-polymer joining proceeds from left to right down the stack.

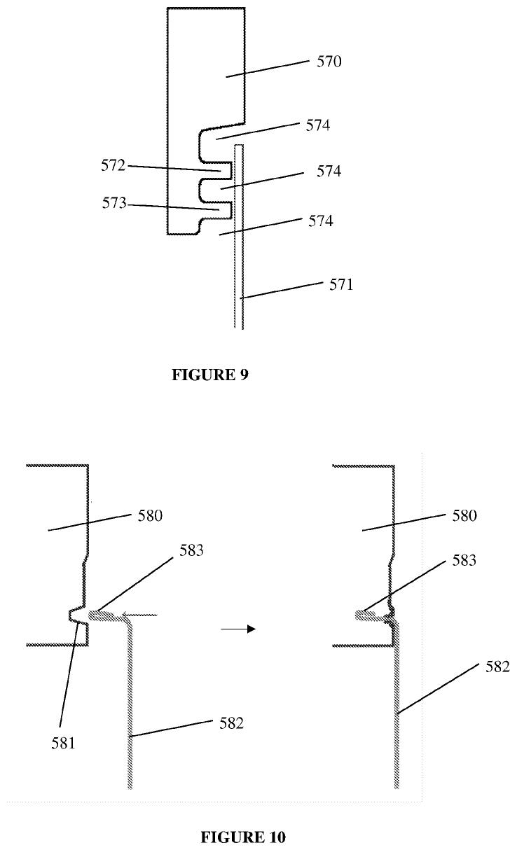

Another tolerance compensation feature is depicted in cross-section in FIG. 9. A polymeric component 570 (e.g. a polymeric cell frame) is attached via the lands of two proud ridges 572 and 573 to a metallic component 571 (e.g. a bipolar plate). The ridges have voids 574 between and about them. During thermal heating of the assembly, the polymeric component 570 may expand more than the metallic component 571. In that case the ridges 572 and 573 are able to distort and bend to accommodate the expansion mismatch without breaking their attachment to the metallic component 571. They are able to do so because of the voids 574 between and about the ridges 572 and 573. Two such ridges may be used to provide for redundancy however any number of ridges may be used, including a single ridge, three ridges, or more ridges. Such a join is termed here a ‘ridged polymer-to-metal’ join.

It is to be understood that the above list of joins incorporating ‘tolerance compensation features’ is not all-inclusive. All forms of polymer-to-polymer, polymer-to-metal, and metal-to-metal joins that include a ‘tolerance compensation feature’ may be used in preferred embodiments.

### Preferred Embodiment Polymer-to-Metal and Polymer-to-Polymer Joins

In various other example aspects, embodiments relate to the polymer-to-polymer and polymer-to-metal joins that may be used in the above cell and cell stack architectures and techniques to seal a cell and/or to seal one component to another component. For example, to seal a polymeric cell frame to a metallic bipolar plate compressive component.

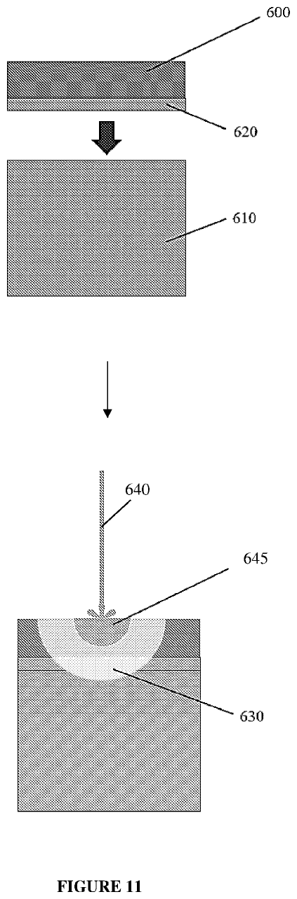

Many such polymer-to-metal joins are created by fluidizing and flowing the polymer component by, for example, melting it in a selected area/volume and then having it flow into or around the metallic component. One preferred polymer-to-metal join is a mechanically engaged join. FIG. 10 schematically depicts in cross-section, an example of the creation of such a join. In this technique, an edge of the metal part is enlarged and then embedded into the polymer surface using heat. A metallic bipolar plate 582, shown in cross-section, has its edge 583 folded over as depicted. The edge 583 is to be attached via a polymer-to-metal join to the polymeric cell frame 580. A notch 581 is created in the surface of the cell frame 580. The folded over edge 583 of metallic bipolar plate 582 is then heated and pressed into the notch 581 as shown by the small arrow in the left-most schematic in FIG. 10. The hot folder-over edge 583 melts the polymer about the notch, with the applied force causing the folder-over edge 583 to embed itself into the body of the polymer 580. Ultimately, the folded over edge 583 is completely embedded in the polymer 580, as depicted in the right-hand schematic in FIG. 10. The heated press tool includes a feature to mould the polymer melt into the joint interface and into the cavity formed within the bipolar plate edge bead, to improve bond mechanical integrity and sealing performance. This technique is known as ‘continuous edge heat staking’ and the join is termed a ‘continuous edge heat staked’ join.

Following on from the above: another preferred polymer-to-metal join involves an apparently uniform metal surface, such as an apparently flat metal surface, joined to a polymer. For such joins, a generally preferred approach to making the polymer-to-metal join robust involves preparing the metal surface prior to attaching it to a polymer surface. Preferred pre-treatments in this regard include but are not limited to:
(1) Cleaning and/or pickling the metal surface with a liquid to remove contaminating materials, such as corrosion residues, oils, and organics; and/or
(2) Texturing the metal surface by, for example, creating microstructures on the surface, such as pits, wells, grooves, porous protrusions, and the like. Preferably structures of this type have ‘undercuts’ or ‘inlays’, or similar internal voids in which the innermost portion of the structure, within the body of the metal, is wider or broader or larger than the outermost, ‘mouth’ portion of that structure, that opens out onto the external metal surface. When a polymer-to-metal join is formed with such a surface by, for example, melting the polymer, the polymer may flow into such voids and solidify there. Because the polymeric structure inside the structure is then larger than the mouth/s of the structure, the polymer is then mechanically held by the metal surface, promoting robust adhesion. Texturing of metal surfaces in this way may preferably but not exclusively be brought about by applying one or more of the following to the surface:
   i. Laser radiation;
   ii. Liquid primers;
   iii. Thermal spray, metal spray (‘cold spray’), or similar techniques;
   iv. Plasma spray, plasma treatments, or similar techniques; or
   v. Certain corona arc techniques.
   Such joins may be broadly referred to as ‘textured metal to polymer’ joins. It is to be understood that a variety of techniques exist to create such joins and the above list is not exhaustive. Any and all such techniques may be used.

FIG. 11 schematically illustrates, in cross-section, a preferred example of this type of polymer-to-metal joining. A metallic part 600 and a polymeric part 610 are to be attached by a polymer-to-metal join. In the first step of the process, the surface of the metallic part 600 that is to be attached (i.e. the bottom surface) is prepared. This may involve texturing the surface as described above by, for example, laser texturing. Alternatively, or additionally, it may involve applying one of the other techniques listed above, or another process not listed above, to thereby increase its capacity to bond to an applied polymer. Many other types of treatment may be employed. A thin polymer layer 620 of the same polymer that is in polymer part 610 is then deposited on the treated surface under carefully controlled conditions that provide for strong and rugged bonding of the thin polymer layer 620 to the treated metallic surface of metallic part 600. The polymeric part 610 is then compressed against the thin polymer layer 620, which is securely attached to the metallic part 600, and the surface of metallic part 600 is subjected to laser irradiation 640 that heats metallic part 600 as shown at region 645 in FIG. 11. The heating causes the polymers at interface 630 to melt and fuse with each other, thereby creating the desired polymer-to-metal join.

Finally, polymer-to-metal joins in which the polymer and metal parts are mechanically interlocked at a macro-scale, may also be used. Such joins may be created by, for example, notching the polymer surface to be joined and then bending an edge of the metal part to fit into and be held by the notch. Rigidity or tension within the metal part, with the optional involvement of a springed/sprung component, may be harnessed. Examples in this respect include but are not limited to purely mechanical polymer-to-metal ‘roll formed’ joins.

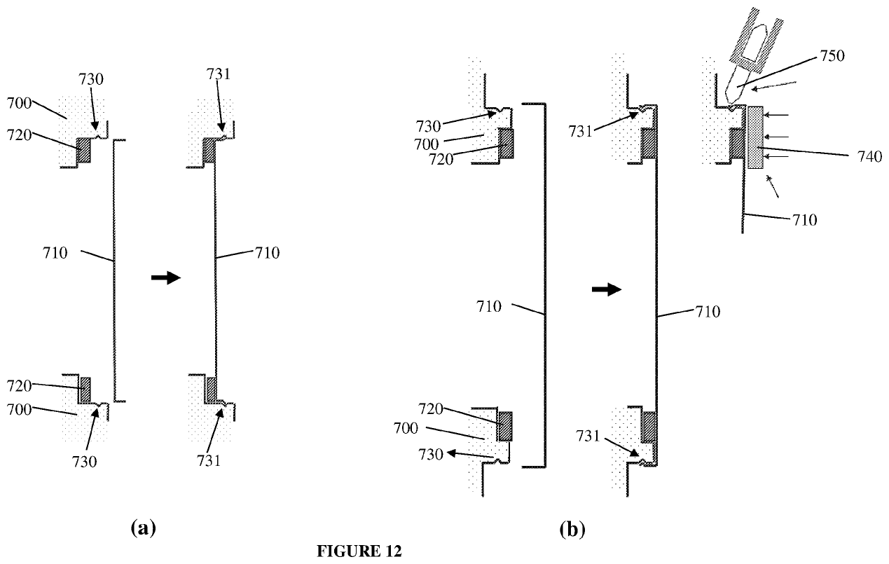

FIG. 12(a) depicts in cross-section an ‘internal roll formed’ join. A polymeric part 700 has a notch 730 in its inner surface. Polymeric part 700 may be, for example, a polymeric cell frame. A gasket 720 may, optionally, be placed on the surface of the polymeric part 700, near to the notch. A metallic part 710 is then placed tight up against the surface of the gasket 720 and/or the polymeric part 700. The metallic part 710 may be, for example, a bipolar plate. The gasket 720 may, optionally, be springed or sprung (e.g. it may be an elastomeric gasket). The metallic part 710 is compressed onto the gasket 720 and/or the surface of the polymeric part 700, causing its edge to be located over the notch 730. This may be done using ‘clamp plate’ 740 (as shown at the top right of FIG. 4(b)). A ‘roll forming’ tool 750 (as depicted on the top right of FIG. 4(b)) is then used to bend the edge of the metallic part 710 into the notch, as depicted at region 731. In so doing, the metallic part may be sealed and locked to the polymeric part 700 (e.g. a metallic bipolar plate may be sealed and locked to a polymeric cell frame). In this case the integrity of the polymer-to-metal seal is maintained by the rigidity of the metallic part 710 between the two internal roll-formed joints at 730.

FIG. 12(b) depicts in cross-section an ‘external roll formed’ join. A polymeric part 700 has a notch 730 in its outer surface. Polymeric part 700 may be, for example, a polymeric cell frame. A gasket 720 may, optionally, be placed on the surface of the polymeric part 700, near to the notch. A metallic part 710 is then placed tight up against the surface of the gasket 720 and/or the polymeric part 700. The metallic part 710 may be, for example, a bipolar plate. The gasket 720 may, optionally, be springed or sprung (e.g. it may be an elastomeric gasket). The metallic part 710 is compressed onto the gasket 720 and/or the surface of the polymeric part 700, causing its edge to be located over the notch 730. This may be done using a ‘clamp plate’ 740 (as shown at the top right of FIG. 4(b)). A ‘roll forming’ tool 750 (as depicted on the top right of FIG. 4(b)) is then used to bend the edge of the metallic part 710 into the notch, as depicted at region 731. In so doing, the metallic part may be sealed and locked to the polymeric part 700 (e.g. a metallic bipolar plate may be sealed and locked to a polymeric cell frame). In this case the integrity of the polymer-to-metal seal is maintained by the tension placed by the two, external roll formed joints on the metallic part 710.

Preferably, but not exclusively, the following polymer-to-metal joins may be used in the above cell and cell stack architectures and techniques:
(1) ‘continuous edge heat staked’ joins,
(2) ‘textured metal to polymer’ joins,
(3) ‘roll formed’ joins.

Other preferred example embodiments include but are not limited to, polymer-to-metal and polymer-to-polymer joins involving the use of:
(1) Chemical binding, with or without chemical adhesion promoting materials, including the application of:
   i. Adhesives and glues of various types, including but not limited to
      1. Adhesives by chemical composition, including: epoxy adhesives, polyurethane adhesives, polyimide adhesives, cyanoacrylate adhesives, polyvinylacetate glue,
      2. Adhesives by physical form, including: adhesive pastes, adhesive gums, adhesive films, adhesive cements, adhesive resins, adhesive bonding agents, elastomeric adhesives, wet adhesives,
      3. Adhesives by classification, including: contact adhesives, reactive adhesives, single-component reactive adhesives, two- or multi-component reactive adhesives, hot-melt adhesives, pressure-sensitive adhesives, thermosetting adhesives,
      4. Adhesives by load-bearing capability, including: structural adhesives, non-structural adhesives, semi-structural adhesives;
(2) Polymer dissolution and re-materialisation, including but not limited to
   i. Solvent welding;
(3) Polymer melting or softening, with or without use of wetting agents that facilitate polymer flow, including but not limited to
   i. Thermal welding,
   ii. Hot plate or platen welding,
   iii. Ultrasonic or vibration welding,
   iv. Laser or laser beam welding,
   v. Hot gas welding,
   vi. Spin welding,
   vii. Friction welding,
   viii. Frequency, or high-frequency, or radio-frequency welding
   ix. Infra-red or non-contact welding,
   x. Speed tip welding,
   xi. Extrusion welding,
   xii. Contact welding,
   xiii. Induction welding, and
   xiv. Injection welding.

It is to be understood that the above list of joins is not all-inclusive. All forms of polymer-to-polymer and polymer-to-metal joins may be used in preferred embodiments.

### Preferred Embodiment Metal-to-Metal Joins

In various other example aspects, embodiments relate to the metal-to-metal joins that may be used in the above cell and cell stack architectures and techniques. Metal-to-metal welds are a particularly preferred form of metal-to-metal joining. A ‘metal-to-metal weld’ as used herein is any form of metallurgical metal-to-metal join that may be considered to involve a weld, including but not limited to fusion welding and pressure welding.

Preferred example embodiments include but are not limited to, metal-to-metal joins involving:
(1) Mechanical joins, including but not limited to joins formed by
   i. Riveting,
   ii. Caulking,
   iii. Bolting,
   iv. Shrink fitting,
   v. Folding;
(2) Chemical joins, including but not limited to joins formed by
   i. Bonding, including bonding metals with glues including electrically conductive glues;
(3) Metallurgical joins, including but not limited to joins formed by
   i. Fusion welding, including:
      1. Electrical energy: Arc welding, electron beam welding,
      2. Chemical energy: gas welding,
      3. Light energy: Laser welding;
   ii. Pressure welding, including:
      1. Electrical energy: resistance welding, including resistance spot welding, projection welding, seam welding, upset welding, flash welding,
      2. Chemical energy: explosion welding,
      3. Mechanical energy: cold pressure welding, friction welding, friction stir welding, ultrasonic welding, diffusion welding;
   iii. Brazing/soldering, including:
      1. Electrical energy: Induction heating brazing, soft brazing, soldering,
      2. Chemical energy: torch brazing, flame brazing,
      3. Light energy: light beam brazing, laser brazing,
      4. ‘Soft soldering’,
      5. ‘Hard soldering’.

It is to be understood that the above list of joins is not all-inclusive. All forms of metal-to-metal joins may be used in preferred embodiments.

### Electro-Energy and Electro-Synthetic Cells and Reactions

In further specific examples, there is provided:
(i) any of the preceding example cells within an alkaline water electrolyser or alkaline fuel cell, where the electrolyte is a hydroxide with pH of more than 10.
(ii) any of the preceding example cells having an electrode separator of less than 0.2 mm thickness.
(iii) any of the preceding example cells having a clamping force on the electrodes that compresses the electrode against the inter-electrode separator by more than 2 bar.
(iv) any of the preceding example cells within an alkaline water electrolyser or alkaline fuel cell, where the electrolyte is a hydroxide with pH more than 10, and having an electrode separator of less than 0.2 mm thickness.
(v) any of the preceding example cells within an alkaline water electrolyser or alkaline fuel cell, where the electrolyte is a hydroxide with pH more than 10, and having a clamping force on the electrodes that compresses the electrode against the inter-electrode separator by more than 2 bar.
(vi) any of the preceding example cells, within an alkaline water electrolyser or alkaline fuel cell, where the electrolyte is a hydroxide with pH more than 10, having a clamping force on the electrodes that compresses the electrode against the inter-electrode separator by more than 2 bar, and having an electrode separator of less than 0.2 mm thickness.

Preferably but not exclusively, the liquid electrolyte used in the above example embodiments comprises a hydroxide salt and has a pH of at least 10. Optionally, the liquid electrolyte used in example embodiments has a pH of less than 10.

Preferably, cells and cell stacks with the above features are electro-energy or electro-synthetic cells or cell stacks, such as: (i) hydrogen-oxygen fuel cells, including Polymer Electrolyte Membrane (PEM) fuel cells or Alkaline fuel cells, (ii) direct alcohol fuel cells, including direct methanol or direct ethanol fuel cells, (iii) phosphoric acid fuel cells, or (iv) ammonia fuel cells.

Preferably, cells and cell stacks with the above features are electro-synthetic cells or cell stacks, such as: (i) water electrolysers, (ii) chlor-alkali electrolyzers, (iii) nitrogen reductions cells for ammonia manufacture, or (iv) CO₂ electrolysers, including combined carbon capture and CO₂ electrolysers.

Preferably, cells and cell stacks with the above features are capillary-fed electro-energy or electro-synthetic cells or cell stacks, of the type described in International Patent Publication Nos. WO2022056603, WO2022056604, WO2022056605, and WO2022056606, which are hereby incorporated by reference.

### Combinations of Features

According to various non-limiting example embodiments, the following points disclose combinations of features that provide various example cells, multi-cell stacks, systems and/or example methods of operation.
1. An electro-energy or electro-synthetic cell comprising:
   a polymeric cell frame;
   a first electrode and a second electrode;
   an inter-electrode separator positioned between the first electrode and the second electrode; and,
   a metallic bipolar plate component,
   wherein the polymeric cell frame is sealed to the metallic bipolar plate compressive component.
2. The electro-energy or electro-synthetic cell of point 1, wherein the bipolar plate component is a compressive component.
3. The electro-energy or electro-synthetic cell of any of the preceding points, wherein the bipolar plate is positioned adjacent to the first electrode.
4. The electro-energy or electro-synthetic cell of any of the preceding points, wherein a seal between the polymeric cell frame and the metallic bipolar plate component is created by a polymer-to-metal join.
5. The electro-energy or electro-synthetic cell of any of the preceding points, wherein at least one polymeric structural locating component locates the metallic bipolar plate component against the polymeric cell frame.
6. The electro-energy or electro-synthetic cell of any of the preceding points, wherein a seal between the polymeric cell frame and the metallic bipolar plate component is created by one or more polymer-to-polymer joins between the at least one polymeric structural locating component and the polymeric cell frame and the at least one polymeric structural locating component mechanically holding the metallic bipolar plate component against the polymeric cell frame.
7. The electro-energy or electro-synthetic cell of any of the preceding points, wherein the first electrode and the second electrode are positioned in the polymeric cell frame.
8. The electro-energy or electro-synthetic cell of any of the preceding points, wherein the polymeric cell frame includes a window cut-out, wherein the first electrode and the second electrode are positioned in the window cut-out.
9. The electro-energy or electro-synthetic cell of any of the preceding points, wherein the inter-electrode separator is a polymeric inter-electrode separator.
10. The electro-energy or electro-synthetic cell of any of the preceding points, wherein the polymeric cell frame is joined to the polymeric inter-electrode separator via a polymer-to-polymer join.
11. The electro-energy or electro-synthetic cell of any of the preceding points, wherein the first electrode is a first metallic electrode.
12. The electro-energy or electro-synthetic cell of any of the preceding points, wherein the metallic bipolar plate component is joined to the first metallic electrode to form a metal-to-metal joined assembly.
13. The electro-energy or electro-synthetic cell of any of the preceding points, further including a metallic porous transport layer positioned between the metallic bipolar plate component and the first metallic electrode.
14. The electro-energy or electro-synthetic cell of any of the preceding points, wherein the metal-to-metal joined assembly further includes the metallic porous transport layer being joined to the metallic bipolar plate component and the first metallic electrode.
15. The electro-energy or electro-synthetic cell of any of the preceding points, further including a second metallic bipolar plate component.
16. The electro-energy or electro-synthetic cell of any of the preceding points, wherein the second metallic bipolar plate is a compressive component.
17. The electro-energy or electro-synthetic cell of any of the preceding points, wherein the second bipolar plate is positioned adjacent to the second electrode on the opposite side to the inter-electrode separator.
18. The electro-energy or electro-synthetic cell of any of the preceding points, wherein the polymeric cell frame is sealed to the second metallic bipolar plate component.
19. The electro-energy or electro-synthetic cell of any of the preceding points, wherein a seal between the polymeric cell frame and the second metallic bipolar plate component is created by a polymer-to-metal join.
20. The electro-energy or electro-synthetic cell of any of the preceding points, wherein at least one further polymeric structural locating component locates the second metallic bipolar plate component against the polymeric cell frame.
21. The electro-energy or electro-synthetic cell of any of the preceding points, wherein a seal between the polymeric cell frame and the second metallic bipolar plate component is created by one or more further polymer-to-polymer joins between the at least one further polymeric structural locating component and the polymeric cell frame and the at least one further polymeric structural locating component mechanically holding the second metallic bipolar plate component against the polymeric cell frame.
22. The electro-energy or electro-synthetic cell of any of the preceding points, wherein:
   the second electrode is a second metallic electrode; and
   the second metallic bipolar plate component is joined to the second metallic electrode to form a second metal-to-metal joined assembly.
23. The electro-energy or electro-synthetic cell of any of the preceding points, further including a second metallic porous transport layer positioned between the second metallic bipolar plate component and the second metallic electrode.
24. The electro-energy or electro-synthetic cell of any of the preceding points, wherein the second metal-to-metal joined assembly further includes the second metallic porous transport layer being joined to the second metallic bipolar plate component and the second metallic electrode.
25. The electro-energy or electro-synthetic cell of any of the preceding points, wherein the polymer-to-metal join is selected from the group of: a continuous edge heat staked join, a textured metal to polymer join, a roll formed join, chemical binding, polymer dissolution and re-materialisation, and polymer melting or softening.
26. The electro-energy or electro-synthetic cell of any of the preceding points, wherein the cell is sealed.
27. The electro-energy or electro-synthetic cell of any of the preceding points, wherein the cell is internally compressed.
28. The electro-energy or electro-synthetic cell of any of the preceding points, wherein the inter-electrode separator is positioned in the window cut-out and joined to the polymeric cell frame.
29 An electro-energy or electro-synthetic cell comprising:
   a polymeric cell frame;
   a first electrode and a second electrode;
   an inter-electrode separator positioned between the first electrode and the second electrode;
   a metallic porous transport layer compressive component positioned adjacent to the first electrode on the opposite side to the inter-electrode separator; and,
   a metallic bipolar plate positioned adjacent to the metallic porous transport layer compressive component on the opposite side to the first electrode,
   wherein at least one polymeric structural locating component locates the metallic bipolar plate against the polymeric cell frame.
30. The electro-energy or electro-synthetic cell of any of the preceding points, wherein the at least one polymeric structural locating component partially encloses the metallic bipolar plate and the first electrode.
31. The electro-energy or electro-synthetic cell of any of the preceding points, wherein the polymeric cell frame is sealed to a metallic porous transport layer component.
32. The electro-energy or electro-synthetic cell of any of the preceding points, wherein a junction between the metallic bipolar plate and the at least one polymeric structural locating component is sealed.
33. The electro-energy or electro-synthetic cell of any of the preceding points, wherein a gasket is positioned at the junction between the metallic bipolar plate and the polymeric cell frame.
34. The electro-energy or electro-synthetic cell of any of the preceding points, wherein a metallic bipolar plate is a compressive component.
35. The electro-energy or electro-synthetic cell of any of the preceding points, wherein a metallic bipolar plate compressive component is provided as a waffle structure.
36. The electro-energy or electro-synthetic cell of any of the preceding points, wherein the first electrode is welded to at least some lands of the waffle structure.
37. The electro-energy or electro-synthetic cell of any of the preceding points, wherein once assembled the metallic bipolar plate compressive component is springed.
38. The electro-energy or electro-synthetic cell of any of the preceding points, wherein a metallic bipolar plate compressive component exerts a clamping force that compresses its electrode against the inter-electrode separator.
39. The electro-energy or electro-synthetic cell of any of the preceding points, wherein a metallic porous transport layer compressive component exerts a clamping force that compresses its electrode against the inter-electrode separator.
40. The electro-energy or electro-synthetic cell of either of the two preceding points, wherein a clamping force applied internally within the cell when assembled, by the metallic bipolar plate compressive component upon the first electrode, compressing the first electrode against the inter-electrode separator, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.
41. The electro-energy or electro-synthetic cell of any of the preceding points, further including a tolerance compensation feature.
42. The electro-energy or electro-synthetic cell of any of the preceding points, wherein the tolerance compensation feature is a channel, a groove, a slot, or a tongue.
43. The electro-energy or electro-synthetic cell of any of the preceding points, wherein the tolerance compensation feature is a positive engagement component, a tongue and groove joint, or a locating pin and well.
44. The electro-energy or electro-synthetic cell of any of the preceding points, wherein the inter-electrode separator is less than 0.35 mm thick, less than 0.2 mm thick, less than 0.1 mm thick, less than 0.05 mm thick, or less than 0.025 mm thick.
45. A cell stack comprising a plurality of the electro-energy or electro-synthetic cells of any of the preceding points.
46. The cell stack of point 45, wherein the polymeric cell frame of one cell in the cell stack is joined to the polymeric cell frame of an adjacent cell in the cell stack.
47. The cell stack of point 45 or 46, wherein the polymeric cell frame of one cell in the cell stack is welded to the polymeric cell frame of an adjacent cell in the cell stack.
48. The cell stack of any of points 45 to 47, wherein the waffle structure of the metallic bipolar plate compressive component in one cell in the cell stack interdigitates with the waffle structure of the metallic bipolar plate compressive component of an adjacent cell in the cell stack.
49. The cell stack of any of points 45 to 48, wherein the waffle structure of the metallic bipolar plate compressive component in one cell in the cell stack is welded to the waffle structure of the metallic bipolar plate compressive component of an adjacent cell in the cell stack.
50. The cell stack of any of points 45 to 49, being a filter-press type cell stack.
51. The cell stack of any of points 45 to 50, wherein a liquid inlet header of the cells within the cell stack is pressurised to a higher pressure than the liquid in each cell, and a liquid outlet header of the cells within the cell stack is pressurised to a lower pressure than the liquid in each cell.
52. The cell stack of any of points 45 to 51, wherein the compression pressure applied to the cell stack is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, or greater than 20 bar.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. An electro-energy or electro-synthetic cell comprising:
a polymeric cell frame;
a first electrode and a second electrode;
an inter-electrode separator positioned between the first electrode and the second electrode; and
a metallic bipolar plate compressive component positioned adjacent to the first electrode,
wherein the polymeric cell frame is sealed to the metallic bipolar plate compressive component.

2. The electro-energy or electro-synthetic cell of claim 1, wherein a seal between the polymeric cell frame and the metallic bipolar plate compressive component is created by a polymer-to-metal join.

3. The electro-energy or electro-synthetic cell of claim 1, wherein at least one polymeric structural locating component locates the metallic bipolar plate compressive component against the polymeric cell frame.

4. The electro-energy or electro-synthetic cell of claim 3, wherein a seal between the polymeric cell frame and the metallic bipolar plate compressive component is created by one or more polymer-to-polymer joins between the at least one polymeric structural locating component and the polymeric cell frame and the at least one polymeric structural locating component mechanically holding the metallic bipolar plate compressive component against the polymeric cell frame.

5. The electro-energy or electro-synthetic cell of claim 1, wherein the first electrode is a first metallic electrode, and the metallic bipolar plate compressive component is welded to the first metallic electrode to form a metal-to-metal joined assembly.

6. (canceled)

7. The electro-energy or electro-synthetic cell of claim 1, wherein the metallic bipolar plate compressive component is provided as a waffle structure.

8. The electro-energy or electro-synthetic cell of claim 7, wherein the first electrode is welded to at least some lands of the waffle structure.

9. The electro-energy or electro-synthetic cell of claim 7, wherein once assembled the metallic bipolar plate compressive component is springed.

10. The electro-energy or electro-synthetic cell of claim 1, wherein the metallic bipolar plate compressive component exerts a clamping force on the first electrode to compress the first electrode against the inter-electrode separator.

11. The electro-energy or electro-synthetic cell of claim 1, wherein the electro-energy or electro-synthetic cell is internally compressed.

12. The electro-energy or electro-synthetic cell of claim 1, wherein a clamping force applied internally within the electro-energy or electro-synthetic cell when assembled, by the metallic bipolar plate compressive component upon the first electrode, compressing the first electrode against the inter-electrode separator, is greater than 0.01 bar, greater than 0.02 bar, greater than 0.03 bar, greater than 0.04 bar, greater than 0.05 bar, greater than 0.075 bar, greater than 0.1 bar, greater than 0.2 bar, greater than 0.3 bar, greater than 0.5 bar, greater than 0.75 bar, greater than 1 bar, greater than 2 bar, greater than 3 bar, greater than 4 bar, greater than 5 bar, greater than 10 bar, greater than 15 bar, or greater than 20 bar.

13. The electro-energy or electro-synthetic cell of claim 1, wherein the inter-electrode separator is less than 0.35 mm thick, less than 0.2 mm thick, less than 0.1 mm thick, less than 0.05 mm thick, or less than 0.025 mm thick.

14. The electro-energy or electro-synthetic cell of claim 1, further including a second metallic bipolar plate compressive component positioned adjacent to the second electrode on the opposite side to the inter-electrode separator.

15. The electro-energy or electro-synthetic cell of claim 14, wherein:
the second electrode is a second metallic electrode; and
the second metallic bipolar plate compressive component is welded to the second metallic electrode to form a second metal-to-metal joined assembly.

16-26. (canceled)

27. The electro-energy or electro-synthetic cell of claim 1, further including a tolerance compensation feature, and wherein the tolerance compensation feature is a channel, a groove, a slot, or a tongue.

28-29. (canceled)

30. A cell stack comprising a plurality of the electro-energy or electro-synthetic cells of claim 1.

31. The cell stack of claim 30, wherein the polymeric cell frame of one cell in the cell stack is joined to the polymeric cell frame of an adjacent cell in the cell stack.

32. The cell stack of claim 30, wherein the polymeric cell frame of one cell in the cell stack is welded to the polymeric cell frame of an adjacent cell in the cell stack.

33-34. (canceled)

35. The cell stack of claim 30, being a filter-press type cell stack.

36. The cell stack of claim 30, wherein a liquid inlet header of the cells within the cell stack is pressurised to a higher pressure than a liquid in each cell, and a liquid outlet header of the cells within the cell stack is pressurised to a lower pressure than the liquid in each cell.

37-42. (canceled)
